(19) United States
(12) Patent Application Publication
(10) Pub. No.: US 2016/0033712 A1
(43) Pub. Date: Feb. 4, 2016

(54) LIGHT GUIDE AND LIGHTING ASSEMBLY WITH ARRAY OF MICRO-OPTICAL ELEMENT GROUPINGS

(71) Applicant: Rambus Delaware LLC, Brecksville, OH (US)

(72) Inventors: Dane A. Sahlhoff, Fremont, CA (US); Juhyun Lee, Aurora, OH (US)

(21) Appl. No.: 14/814,613

(22) Filed: Jul. 31, 2015

Related U.S. Application Data
(60) Provisional application No. 62/076,089, filed on Nov. 6, 2014.
(60) Provisional application No. 62/031,199, filed on Jul. 31, 2014.

(51) Int. Cl. F21V 8/00

(52) U.S. Cl. CPC G02B 6/0036; G02B 6/0061; G02B 6/0073

(57) ABSTRACT

A light guide includes a first major surface, an opposed second major surface, and a light input edge extending therebetween. Micro-optical elements at at least one of the first major surface and the second major surface are arranged in an array of micro-optical element groupings. Each grouping includes a first micro-optical element and a second micro-optical element adjacent the first micro-optical element and arranged along a light propagation path extending from the light input edge. In some embodiments, the second micro-optical element is configured to redirect at least a portion of light propagating along the light propagation path and incident thereon toward the first micro-optical element such that the redirected light is incident the first micro-optical element and extracted from the light guide. In other embodiments, the second micro-optical element is configured to redirect at least a portion of the propagating light incident thereon away from the first micro-optical element.

### RELATED APPLICATION DATA

This application claims the benefit of U.S. Provisional Patent Application No. 62/031,199, filed Jul. 31, 2014; and claims the benefit of U.S. Provisional Patent Application No. 62/076,089, filed Nov. 6, 2014; the disclosures of which are incorporated herein by reference in their entireties.

### BACKGROUND

Energy efficiency has become an area of interest for energy consuming devices. One class of energy consuming devices is lighting devices. Light emitting diodes (LEDs) show promise as energy efficient light sources for lighting devices. But control over light output distribution is an issue for lighting devices that use LEDs or similar light sources.

### BRIEF DESCRIPTION OF THE DRAWINGS

FIGS. 1 and 2 are schematic perspective views of exemplary lighting assemblies.

FIG. 3 is a schematic cross-sectional view of parts of an exemplary lighting assembly including a micro-optical element.

FIG. 4 is a schematic view of parts of an exemplary lighting assembly.

FIG. 4A is a schematic view of an exemplary micro-optical element grouping.

FIGS. 5-7 are schematic views of parts of exemplary lighting assemblies.

FIGS. 8-10 are schematic views of exemplary micro-optical element groupings.

FIG. 11 is a schematic cross-sectional view of parts of an exemplary lighting assembly including a micro-optical element grouping.

FIGS. 12-15 are schematic cross-sectional views of exemplary lighting assemblies including a micro-optical element grouping.

FIGS. 16, 16A, 17, 18, 18A, 19, 20, 20A, and 21 are schematic views of exemplary micro-optical element groupings.

FIG. 22 is a schematic view of parts of an exemplary lighting assembly.

FIGS. 22A and 22B are schematic views of exemplary micro-optical element groupings.

FIG. 23 is a schematic perspective view of an exemplary lighting assembly.

FIG. 24 is an output distribution profile of the exemplary lighting assembly of FIG. 23.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments. In this disclosure, angles of incidence, reflection, and refraction and output angles are measured relative to the normal to the surface (e.g., the major surface).

In accordance with one aspect of the present disclosure, a light guide includes: a first major surface; a second major surface opposed the first major surface; a light input edge extending between the first major surface and the second major surface, the first major surface and the second major surface configured to propagate light input to the light guide through the light input edge therebetween by total internal reflection; and micro-optical elements at at least one of the first major surface and the second major surface, the micro-optical elements arranged in an array of micro-optical element groupings, each micro-optical element grouping including: a first micro-optical element; and a second micro-optical element adjacent the first micro-optical element and arranged along a light propagation path extending from the light input edge, the second micro-optical element configured to redirect at least a portion of light propagating along the light propagation path and incident thereon toward the first micro-optical element such that the redirected light is incident the first micro-optical element and extracted from the light guide.

In accordance with another aspect of the present disclosure, a light guide includes: a first major surface; a second major surface opposed the first major surface; a light input edge extending between the first major surface and the second major surface, the first major surface and the second major surface configured to propagate light input to the light guide through the light input edge therebetween by total internal reflection; and micro-optical elements at at least one of the first major surface and the second major surface, the micro-optical elements arranged in an array of micro-optical element groupings, each micro-optical element grouping including: a first micro-optical element; and a second micro-optical element adjacent the first micro-optical element and arranged along a light propagation path extending from the light input edge, the second micro-optical element configured to redirect at least a portion of light propagating along the light propagation path and incident thereon away from the first micro-optical element.

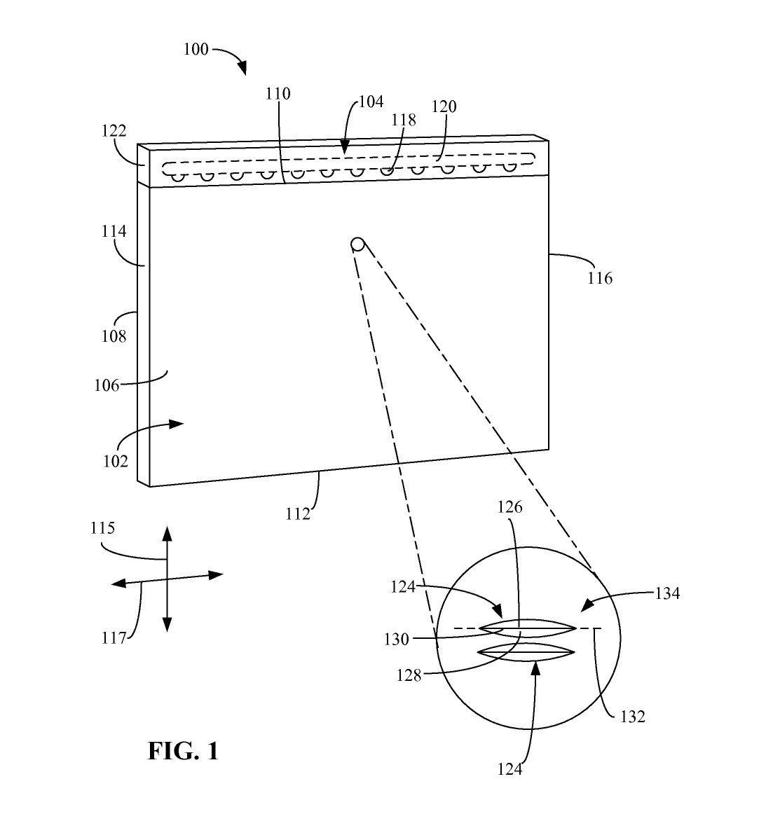

With initial reference to FIG. 1, an exemplary embodiment of a lighting assembly is shown at 100. The lighting assembly 100 includes a light guide 102. The light guide 102 is a solid article of manufacture made from, for example, polycarbonate, poly(methyl-methacrylate) (PMMA), glass, or other appropriate material. The light guide 102 may also be a multi-layer light guide having two or more layers that may differ in refractive index. The light guide 102 includes a first major surface 106 and a second major surface 108 opposite the first major surface 106. The light guide 102 is configured to propagate light by total internal reflection between the first major surface 106 and the second major surface 108. The length and width dimensions of each of the major surfaces 106, 108 are greater, typically ten or more times greater, than the thickness of the light guide 102. The thickness is the dimension of the light guide 102 in a direction orthogonal to the major surfaces 106, 108. The thickness of the light guide 102 may be, for example, about 0.1 millimeters (mm) to about 10 mm.

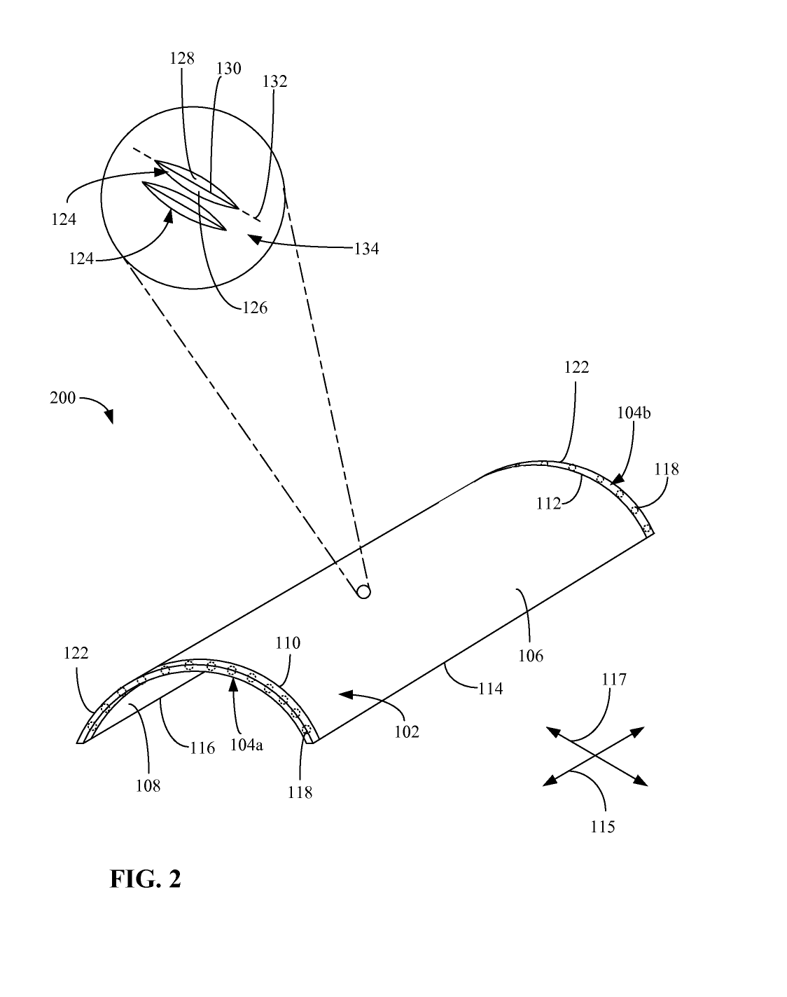

At least one edge surface extends between the major surfaces 106, 108 of the light guide in the thickness direction. The total number of edge surfaces depends on the configuration of the light guide. In the case where the light guide is rectangular, the light guide has four edge surfaces 110, 112, 114, 116. In the embodiment shown, the light guide extends in a longitudinal direction 115 between edge surface 110 and edge surface 112; and extends in a lateral direction 117 between edge surface 114 and edge surface 116. Other light guide shapes result in a corresponding number of side edges. Although not shown, in some embodiments, the light guide 102 may additionally include one or more edge surfaces defined by the perimeter of an orifice extending through the light guide in the thickness direction. Each edge surface defined by the perimeter of an orifice extending through the light guide 102 will hereinafter be referred to as an internal edge surface. Depending on the shape of the light guide 102, each edge surface may be straight or curved, and adjacent edge surfaces may meet at a vertex or join in a curve. Moreover, each edge surface may include one or more straight portions connected to one or more curved portions. The edge surface through which light from the light source 104 is input to the light guide will now be referred to as a light input edge. In the embodiment shown in FIG. 1, the edge surface 110 is a light input edge. In some embodiments, the light guide 102 includes more than one light input edge. As an example, FIG. 2 shows an embodiment of a lighting assembly 200 in which each of edge surfaces 110 and 112 are embodied as light input edges. Furthermore, the one or more light input edges may be straight and/or curved.

In the embodiment shown in FIG. 1, the major surfaces 106, 108 are planar. In other embodiments, at least a portion of the major surfaces 106, 108 of the light guide 102 is curved in one or more directions. In one example, the intersection of the light input edge 110 and one of the major surfaces 106, 108 defines a first axis, and at least a portion of the light guide 102 curves about an axis parallel to the first axis. In another example, at least a portion of the light guide 102 curves about an axis orthogonal to the first axis. As an example, FIG. 2 shows an embodiment of the lighting assembly 200 wherein the light guide 102 is embodied as a semi-cylindrical body curving about an axis that extends in the longitudinal direction 115 between edge surface 110 and edge surface 112 (e.g., an axis orthogonal to an axis defined by the intersection of the light input edge 110 and one of the major surfaces 106, 108). As shown in FIG. 2, the light guide extends in a longitudinal direction 115 between edge surface 110 and edge surface 112; and extends in a lateral direction 117 between edge surface 114 and edge surface 116. Other exemplary shapes of the light guide include a dome, a hollow cylinder, a hollow cone or pyramid, a hollow frustrated cone or pyramid, a bell shape, an hourglass shape, or another suitable shape.

With continued reference to FIG. 1, the lighting assembly 100 includes a light source 104 positioned adjacent the light input edge 110. The light source 104 is configured to edge light the light guide 102 such that light from the light source 104 enters the light input edge 110 and propagates along the light guide 102 by total internal reflection at the major surfaces 106, 108. In embodiments where the light guide includes more than one light input edge, the lighting assembly 100 may include a corresponding number of light sources 104. As shown, for example, in FIG. 2, the lighting assembly 200 may include a first light source 104a adjacent the light input edge 110, and a second light source 104b adjacent the light input edge 112. The first and second light sources 104a, 104b may be collectively referred to as light source 104.

The light source 104 includes one or more solid-state light emitters 118. The solid-state light emitters 118 constituting the light source 104 are arranged linearly or in another suitable pattern depending on the shape of the light input edge of the light guide 102 to which the light source 104 supplies light. Exemplary solid-state light emitters 118 include such devices as LEDs, laser diodes, and organic LEDs (OLEDs). In an embodiment where the solid-state light emitters 118 are LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light), or a mixture of broad-spectrum LEDs and LEDs that emit narrow-band light of a desired color. In one embodiment, the solid-state light emitters 118 emit light with no operably-effective intensity at wavelengths greater than 500 nanometers (nm) (i.e., the solid-state light emitters 118 emit light at wavelengths that are predominantly less than 500 nm). In some embodiments, the solid-state light emitters 118 constituting light source 104 all generate light having the same nominal spectrum. In other embodiments, at least some of the solid-state light emitters 118 constituting light source 104 generate light that differs in spectrum from the light generated by the remaining solid-state light emitters 118. For example, two different types of solid-state light emitters 118 may be alternately located along the light source 104.

Each solid-state light emitter 118 emits light at a light ray angle distribution relative to an optical axis 119 (e.g., FIG. 7) of the solid-state light emitter 118. The optical axis 119 is defined as an axis extending orthogonally from the center of the light emitting surface of the solid state light emitter 118. The solid-state light emitter 118 may be arranged so that the optical axis 119 is perpendicular to the light input edge.

The lighting assembly 100 may include one or more additional components. For example, although not specifically shown in detail, in some embodiments of the lighting assembly, the light source 104 includes structural components to retain the solid-state light emitters 118. In the example shown in FIG. 1, the solid-state light emitters 118 are mounted to a printed circuit board (PCB) 120. The light source 104 may additionally include circuitry, power supply, electronics for controlling and driving the solid-state light emitters 118, and/or any other appropriate components.

The lighting assembly 100 may additionally include a housing 122 for retaining the light source 104 and the light guide 102. The housing 122 may retain a heat sink or may itself function as a heat sink. In some embodiments, the lighting assembly 100 includes a mounting mechanism (not shown) to mount the lighting assembly to a retaining structure (e.g., a ceiling, a wall, etc.).

The lighting assembly 100 may additionally include a reflector (not shown) adjacent one of the major surfaces 106, 108. The light extracted through the major surface adjacent the reflector may be reflected by the reflector, re-enter the light guide 102 at the major surface, and be output from the light guide 102 through the other major surface.

The light guide 102 includes light extracting elements embodied as micro-optical elements 124 in, on, or beneath at least one of the major surfaces 106, 108. Micro-optical elements that are in, on, or beneath a major surface will be referred to as being “at” the major surface. The micro-optical elements 124 are features of well-defined shape that predictably reflect or refract the light propagating in the light guide 102. In some embodiments, at least one of the micro-optical elements 124 is an indentation in the major surface 106, 108 of well-defined shape. In other embodiments, at least one of the micro-optical elements 124 is a protrusion from the major surface 106, 108 of well-defined shape. A micro-optical element of well-defined shape is a three-dimensional feature recessed into a major surface or protruding from a major surface having distinct surfaces on a scale larger than the surface roughness of the major surfaces 106, 108. Micro-optical elements and micro-features of well-defined shape exclude features of indistinct shape or surface textures, such as printed features of indistinct shape, ink jet printed features of indistinct shape, selectively-deposited features of indistinct shape, and features of indistinct shape wholly formed by chemical etching or laser etching.

Light guides having micro-optical elements are typically formed by a process such as injection molding. The light-extracting elements are typically defined in a shim or insert used for injection molding light guides by a process such as diamond machining, laser micromachining, photolithography, or another suitable process. Alternatively, any of the above-mentioned processes may be used to define the light-extracting elements in a master that is used to make the shim or insert. In other embodiments, light guides without micro-optical elements are typically formed by a process such as injection molding or extruding, and the light-extracting elements are subsequently formed on one or both of the major surfaces by a process such as stamping, embossing, or another suitable process. Each micro-optical element 124 functions to disrupt the total internal reflection of the light propagating in the light guide and incident thereon. In one embodiment, the micro-optical elements 124 reflect light toward the opposing major surface so that the light exits the light guide 102 through the opposing major surface. Alternatively, the micro-optical elements 124 transmit light through the micro-optical elements 124 and out of the major surface of the light guide 102 having the micro-optical elements 124. In another embodiment, both types of micro-optical elements 124 are present. In yet another embodiment, the micro-optical elements 124 reflect some of the light and refract the remainder of the light incident thereon. Therefore, the micro-optical elements 124 are configured to extract light from the light guide 102 through one or both of the major surfaces 106, 108.

The micro-optical elements 124 are configured to extract light in a defined intensity profile (e.g., a uniform intensity profile) and with a defined light ray angle distribution from one or both of the major surfaces 106, 108. In this disclosure, intensity profile refers to the variation of intensity with regard to position within a light-emitting region (such as the major surface or a light output region of the major surface). The term light ray angle distribution is used to describe the variation of the intensity of light with ray angle (typically a solid angle) over a defined range of light ray angles. In an example in which the light is emitted from an edge-lit light guide, the light ray angles can range from −90° to +90° relative to the normal to the major surface.

Micro-optical elements 124 are small relative to the linear dimensions of the major surfaces 106, 108. The smaller of the length and width of a micro-optical element 124 is less than one-tenth of the longer of the length and width (or circumference) of the light guide 102 and the larger of the length and width of the micro-optical element 124 is less than one-half of the smaller of the length and width (or circumference) of the light guide 102. The length and width of the micro-optical element 124 is measured in a plane parallel to the major surface 106, 108 of the light guide 102 for planar light guides or along a surface contour for non-planar light guides 102.

The micro-optical elements 124 can be any suitable shape. As an example, the light guides 102 respectively shown in FIGS. 1 and 2 include micro-optical elements 124 at the major surface 106 configured as v-groove-shaped depressions having an arcuate ridge, hereinafter referred to as “football-shaped” micro-optical elements. A football-shaped micro-optical element resembles the profile of the ball used in American football. Each football-shaped micro-optical element 124 includes a first side surface 126 and a second side surface 128 that come together to form a ridge 130 having ends that intersect the one of the major surfaces 106, 108 at which the micro-optical element 124 is formed. The included angle formed between the first side surface 126 and the second side surface 128 may be any suitable angle. The included angles of the respective micro-optical elements 124 may be set for extracting light from the light guide 102 at a defined intensity profile and/or light ray angle distribution. As an example, the included angles of the respective football-shaped micro-optical elements 124 may range from 30 degrees to 165 degrees. In some embodiments, at least one of the first side surface 126 and the second side surface 128 is curved. In other embodiments, at least one of the first side surface 126 and the second side surface 128 is planar. In some embodiments, the first side surface 126 and the second side surface 128 are symmetric relative to a plane extending parallel to and intersecting the ridge 130, and extending normal to the major surface. In other embodiments, the first side surface 126 and the second side surface 138 are asymmetric relative to a plane extending parallel to and intersecting the ridge 130, and extending normal to the major surface.

Other exemplary embodiments of the light guide 102 may include micro-optical elements 124 having other suitable shapes. In an example, one or more of the micro-optical elements may be configured as a dragged truncated cone (not shown) having a pair of opposed oppositely sloping planar sides and opposed oppositely rounded or curved ends, and a planar top intersecting the oppositely sloping sides and oppositely rounded ends. Other exemplary micro-optical elements 124 are described in U.S. Pat. No. 6,752,505, the entire content of which is incorporated by reference, and, for the sake of brevity, are not described in detail in this disclosure.

In some embodiments, at least a portion of the micro-optical elements 124 each include a longitudinal axis. The longitudinal axis extends in a plane parallel to the major surface 106, 108 of the light guide 102 for planar light guides or along a surface contour for non-planar light guides 102. With reference to FIG. 1, each football-shaped micro-optical element includes a longitudinal axis 132 extending parallel to the ridge 130. In other embodiments where the micro-optical element is a shape other than the football shape, the longitudinal axis may be defined by one of the length or width of the micro-optical element in a plane parallel to the major surface 106, 108 of the light guide 102 for planar light guides or along a surface contour for non-planar light guides 102. As an example, for a dragged truncated cone (not shown), the longitudinal axis may extend along its length and intersect its oppositely rounded ends.

In some embodiments, the longitudinal axis extends along the longer of the length or width of the micro-optical element. In other embodiments, the longitudinal axis extends along the shorter of the length or width of the micro-optical element. In some embodiments where the length and the width of the micro-optical element are the same (e.g., a micro-optical element having a square base), the longitudinal axis may extend along one of the length or the width of the micro-optical element. The longitudinal axis may be arranged closer to parallel to the light input edge than an axis extending perpendicular to the longitudinal axis and along the other of the length or width of the micro-optical element.

The longitudinal axis is distinguishable from other axes of the micro-optical element extending in a plane parallel to the major surface 106, 108 of the light guide 102 for planar light guides or along a surface contour for non-planar light guides 102. Accordingly, some micro-optical elements (e.g., a conical or frustoconical micro-optical element having a circular base) may not have a distinguishable longitudinal axis.

In some embodiments, the micro-optical elements have the same or nominally the same shape, size, depth, height, slope angle, included angle, surface roughness, and/or index of refraction. The term “nominally” encompasses variations of one or more parameters that fall within acceptable tolerances in design and/or manufacture. As an example, each of the micro-optical elements 124 may have the same or nominally the same football shape shown in FIGS. 1 and 2. In other embodiments, the micro-optical elements may vary in one or more of shape, size, depth, height, slope angle, included angle, surface roughness, and/or index of refraction. This variation in micro-optical elements may achieve a desired light output from the light guide over the corresponding major surface(s). Accordingly, the reference numeral 124 will be generally used to collectively refer to the different embodiments of micro-optical elements.

Each micro-optical element 124 includes at least one surface configured to refract or reflect light propagating in the light guide 102 and incident thereon such that the light is extracted from the light guide. Such surface(s) is also herein referred to as a light-redirecting surface. With exemplary reference to the football-shaped micro-optical element 124 shown in FIG. 1, at least one of the first side surface 126 and the second side surface 128 is a light-redirecting surface.

In some embodiments, the micro-optical elements 124 (e.g., the first side surface 126 and the second side surface 128) have a low surface roughness. In this disclosure, the term “low surface roughness” refers to a defined surface roughness suitable for specularly reflecting or refracting incident light. In one embodiment, the low surface roughness is an average surface roughness (R_{a-low}) less than about 10.0 nm as measured in an area of 0.005 mm². In another embodiment, the low surface roughness is an average surface roughness (R_{a-low}) less than about 5.0 nm as measured in an area of 0.005 mm². In another embodiment, the low surface roughness is an average surface roughness (R_{a-low}) less than about 1.0 nm as measured in an area of 0.005 mm². A micro-optical element with all of its surfaces having a low surface roughness will also be referred to as a low surface roughness micro-optical element. As an example, in some embodiments, the low surface roughness micro-optical elements may have an average surface roughness (R_{a-low}) ranging from about 0.5 nm to about 5.0 nm as measured in an area of 0.005 mm².

In some embodiments, at least a portion of the micro-optical elements 124 include at least one surface having a high surface roughness. In this disclosure, the term “high surface roughness” refers to a defined surface roughness suitable for imparting a diffuse component to incident light that is reflected or refracted. The high surface roughness is greater than the low surface roughness described above. The high surface roughness is a defined roughness intentionally imparted to the at least one surface of the micro-optical element. In one embodiment, the high surface roughness is an average surface roughness (R_{a-high}) equal or greater than about 0.10 μm as measured in an area of 0.005 mm². In another embodiment, the high surface roughness is an average surface roughness (R_{a-high}) ranging from about 0.10 μm to about 5.0 μm as measured in an area of 0.005 mm². In another embodiment, the high surface roughness is an average surface roughness (R_{a-high}) ranging from about 0.30 μm to about 3.0 μm as measured in an area of 0.005 mm². In another embodiment, the high surface roughness is an average surface roughness (R_{a-high}) ranging from about 0.30 μm to about 1.0 μm as measured in an area of 0.005 mm².

The ability to control an output distribution of the light from the lighting assembly allows the lighting assembly to have high application efficiency (e.g., as a lighting fixture for general lighting applications). While the intensity profile and light ray angle distribution may be controlled to some extent by controlling the shape geometry of the micro-optical elements 124 that are configured to extract the light from the light guide 102, a portion of the light may also be extracted by the micro-optical elements 124 in an unwanted direction (e.g., in a direction that falls outside a predefined light ray angle distribution).

Light extraction from the light guide 102 occurs over a range of angles, such output resulting from light propagating in the light guide at different modes and being incident the light-redirecting surface of the micro-optical element 124 at different angles. Light incident the light redirecting surface of the micro-optical element 124 at certain angles may result in a portion of the light being extracted from the lighting guide 102 at an undesired angle. As an example, where the lighting assembly is embodied as a lighting fixture, one example of light being output at an undesired angle is light extracted as high-angle light (e.g., glare light). In the context of a ceiling or hanging lighting fixture, the micro-optical element may be designed to extract low-angle light from the light guide (e.g., light extracted at an angle lower than 45° from normal to the light guide). However, light propagating in the light guide and incident the micro-optical element may also be extracted from the micro-optical element as high-angle light (e.g., light extracted at an angle greater than 45° from normal to the light guide) from the light guide, which may cause glare for an observer.

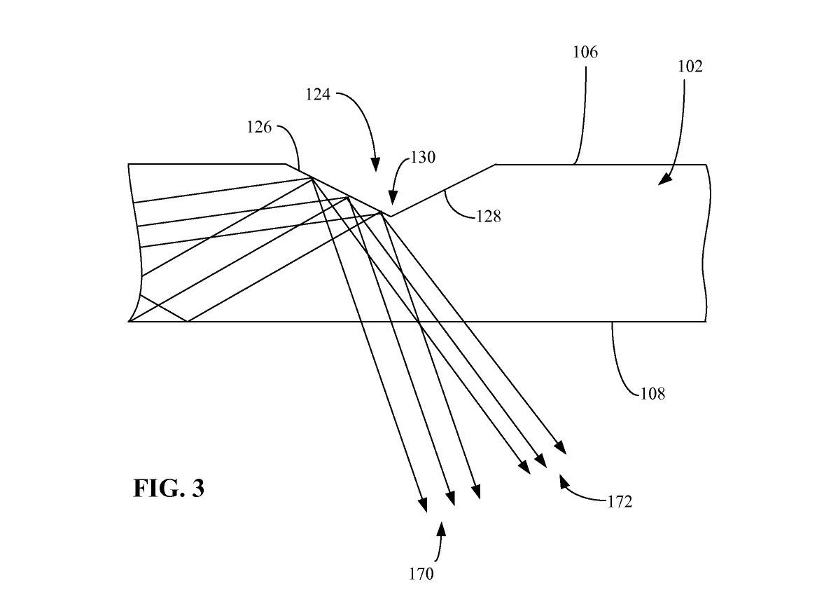

FIG. 3 exemplifies the extraction of light from the light guide 102 by a micro-optical element 124. A cross-section of the micro-optical element 124 is shown as an indentation (e.g., a football-shaped micro-optical element) in a major surface 106 of the light guide 102 and having an included angle of about 120°. In the exemplary embodiment, the light-redirecting surface (first side surface 126) of the micro-optical element is configured to reflect at least a portion of the light incident thereon, thereby extracting the light from the light guide 102 through the opposed major surface 108. A portion of the propagating light 170 that is incident the micro-optical element 124 may be reflected and output at an angle within a predetermined light ray angle distribution. (e.g., light output at an angle lower than 45° from normal to the major surface of the light guide). However, another portion of the propagating light 172 that is incident the micro-optical element 124 may be reflected and output as high-angle light (e.g., light extracted at an angle greater than 45° from normal to the light guide) from the light guide 102.

While one or more optical adjusters (not shown) located adjacent one or both of the major surfaces 106, 108 may help to redirect light extracted from the light guide (e.g., the light such as glare light that may be extracted in an unwanted direction falling outside the predetermined light ray angle distribution), the use of the optical adjusters for such purpose lowers the efficiency of the lighting assembly 100. Furthermore, in many applications (e.g., as a lighting fixture, a sign, a display apparatus, etc.), the use of an optical adjuster is not preferable (e.g., for aesthetic reasons). In addition, the use of an optical adjuster adds cost to the lighting assembly.

Furthermore, because the light-redirecting surface of the micro-optical element 124 is typically arranged as facing the light input edge so that the light input to the light guide and propagating therein is incident on the light-redirecting surface at an angle that will extract the light (e.g., via reflection or refraction), the micro-optical elements may be limited in their ability to extract light in different desired directions. With exemplary reference to FIG. 1, a micro-optical element arranged to extract light from the light guide that is input through light input edge 110 will typically extract light primarily in the longitudinal direction 115. Such an arrangement may not spread the light in the lateral direction 117 to the extent desired for a particular application.

Some lighting assembly designs also do not allow for light sources to be positioned at other or additional edge surfaces (e.g., edge surfaces 114, 116) in order to achieve a desired light output distribution. And similar to the above, while one or more optical adjusters (not shown) located adjacent one or both of the major surfaces 106, 108 may help to redirect light extracted from the light guide 102, use of the optical adjuster for such purpose lowers the efficiency of the lighting assembly 100. And in addition to adding cost to the lighting assembly, in many applications, use of the optical adjuster may not be preferable (e.g., for aesthetic reasons).

In accordance with the present disclosure, the micro-optical elements 124 are arranged as micro-optical elements groupings 134 at at least one of the major surfaces 106, 108 of the light guide 102. The term “micro-optical element grouping” is defined as two or more micro-optical elements 124 arranged and configured in a predetermined manner with respect to one another such that the incidence of propagating light on one of the micro-optical elements of the grouping is affected by another one of the micro-optical elements of the grouping.

In some embodiments, one of the micro-optical elements 124 of the grouping 134 may be configured to redirect at least a portion of the light incident thereon away from a propagation path that would cause the light to be incident another of the micro-optical elements of the grouping 134. Accordingly, in some embodiments, light that if incident the other micro-optical element would cause glare light may either be extracted from the light guide 102 within the desired light ray angle distribution, or may be redirected and totally internally reflected in a manner such that the light is not incident the other micro-optical element. In such embodiments, the other of the grouped micro-optical elements may be regarded as being at least partially “shadowed” by the one of the grouped micro-optical elements.

In other embodiments, one of the micro-optical elements 124 of the grouping 134 may be configured to redirect at least a portion of the light incident thereon in a direction toward the other of the micro-optical elements of the grouping 134. For example, light input into and propagating in the light guide 102 may be incident the one of the grouped micro-optical elements, and reflected thereby or transmitted therethrough, such that the light is incident the other of the grouped micro-optical elements and extracted from the light guide within the desired light ray angle distribution.

The micro-optical element groupings 134 may include any suitable number and arrangement of micro-optical elements. In some embodiments, for a given micro-optical element grouping 134, the respective micro-optical elements 124 have the same or nominally the same orientation, shape, size, depth, height, slope angle, included angle, surface roughness, and/or index of refraction. In other embodiments, for a given micro-optical element grouping 134, one or more of the micro-optical elements 124 in the micro-optical element grouping 134 may differ in orientation, shape, size, depth, height, slope angle, included angle, surface roughness, and/or index of refraction. Accordingly, the reference numeral 134 will be generally used to collectively refer to the different embodiments of micro-optical element groupings.

The micro-optical elements 124 may be arranged in an array 136 of micro-optical element groupings 134 arranged relative and corresponding to the light input edge. The array 127 may include any suitable arrangement of micro-optical element groupings 134. In some embodiments, the respective micro-optical element groupings 134 have the same or nominally the same arrangement of micro-optical elements and/or number of micro-optical elements. In other embodiments, the respective micro-optical element groupings 134 may vary in the arrangement, number, shape, size, depth, height, slope angle, included angle, surface roughness, and/or index of refraction of the micro-optical elements.

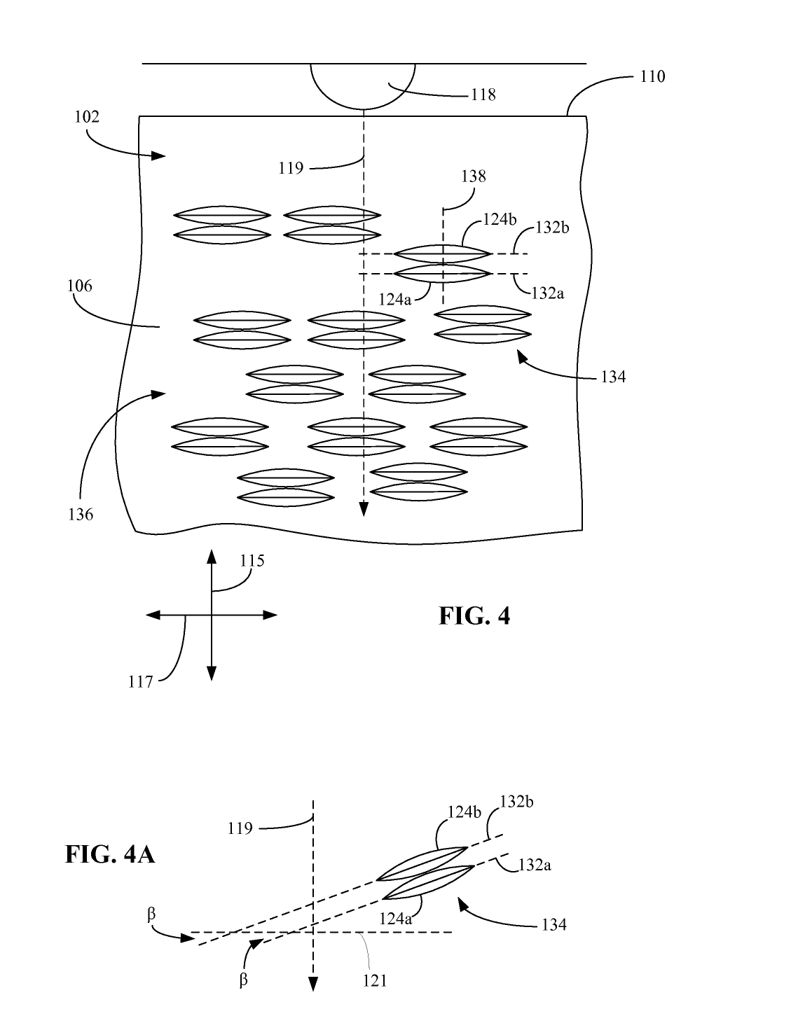

FIG. 4 shows parts of a lighting assembly 100 including an exemplary array 136 of micro-optical element groupings 134. In the embodiment shown, each micro-optical element grouping 134 includes a first micro-optical element 124a adjacent to a second micro-optical element 124b. The first micro-optical element 124a and the second micro-optical element 124b have respective longitudinal axes 132a, 132b arranged at nominally the same orientation (e.g., parallel to one another). The first micro-optical element 124a and the second micro-optical element 124b are aligned along an axis 138 that extends in the longitudinal direction 115 (e.g., orthogonal to an axis defined by the intersection of the light input edge 110 and one of the major surfaces 106, 108). The first micro-optical element 124a of a micro-optical element grouping 134 is located further from the light input edge 110 than the second micro-optical element 124b.

In the example shown in FIG. 4, each micro-optical element grouping 134 in the array 136 is arranged at nominally the same orientation relative to the light input edge 110. As shown, each micro-optical element grouping 134 is arranged such that the longitudinal axes 132a, 132b are nominally parallel to the light input edge (e.g., parallel to an axis defined by the intersection of the light input edge 110 and one of the major surfaces 106, 108). In other embodiments, the micro-optical element groupings 134 may have their respective longitudinal axes 132a, 132b arranged at an angle relative to the light input edge 110. For example, with reference to FIG. 4A, the micro-optical elements 124 may be arranged with their longitudinal axes 132a, 132b within the range of ±13° relative to the light input edge (e.g., relative to an axis 121 extending parallel to the intersection of the light input edge 110 and one of the major surfaces 106, 108). β is a positive or negative value to reference the direction of rotation of the micro-optical element relative to the corresponding light input edge. Rotation in a counter-clockwise direction may provide a positive value of β. Although not specifically shown, rotation in a clockwise direction may provide a negative value of β. In some embodiments, this correlation of rotation direction to positive/negative angle may be reversed (e.g., counter-clockwise is considered negative and clockwise is considered positive).

In one example, the micro-optical element groupings 134 are arranged such that their respective longitudinal axes 132a, 132b are arranged within the range of +45° to −45° (±β°) relative to the light input edge; and the respective rotational orientations from among the rotational orientations of the longitudinal axes 132a, 132b of the other micro-optical element groupings 134 in the array 136 may differ by no more than 90°. In another example, the micro-optical element groupings 134 are arranged such that their respective longitudinal axes 132a, 132b are arranged within the range of +30° to −30° (±) β° relative to the light input edge; and the respective rotational orientations from among the rotational orientations of the longitudinal axes 132a, 132b of the other micro-optical element groupings 134 in the array 136 may differ by no more than 60°. In another example, the micro-optical element groupings 134 are arranged such that their respective longitudinal axes 132a, 132b are arranged within the range of +15° to −15° (±β°) relative to the light input edge; and the respective rotational orientations from among the rotational orientations of the longitudinal axes 132a, 132b of the other micro-optical element groupings 134 in the array 136 may differ by no more than 30°. In another example, the micro-optical element groupings 134 are arranged such that their respective longitudinal axes 132a, 132b are arranged within the range of +10° to −10° (±β°) relative to the light input edge; and the respective rotational orientations from among the rotational orientations of the longitudinal axes 132a, 132b of the other micro-optical element groupings 134 in the array 136 may differ by no more than 20°.

Accordingly, in some embodiments, the micro-optical element groupings 134 may be oriented in the same manner relative to the light input edge (e.g., whether the longitudinal axes 132a, 132b are parallel to the light input edge or at an angle to the light input edge). In other embodiments, a portion of the micro-optical element groupings 134 that make up the array 136 may be arranged such that their longitudinal axes 132a, 132b are parallel to the light input edge; and another portion of the micro-optical element groupings 134 that make up the array 136 may be arranged such that the longitudinal axes 132a, 132b are arranged at an angle relative to the light input edge.

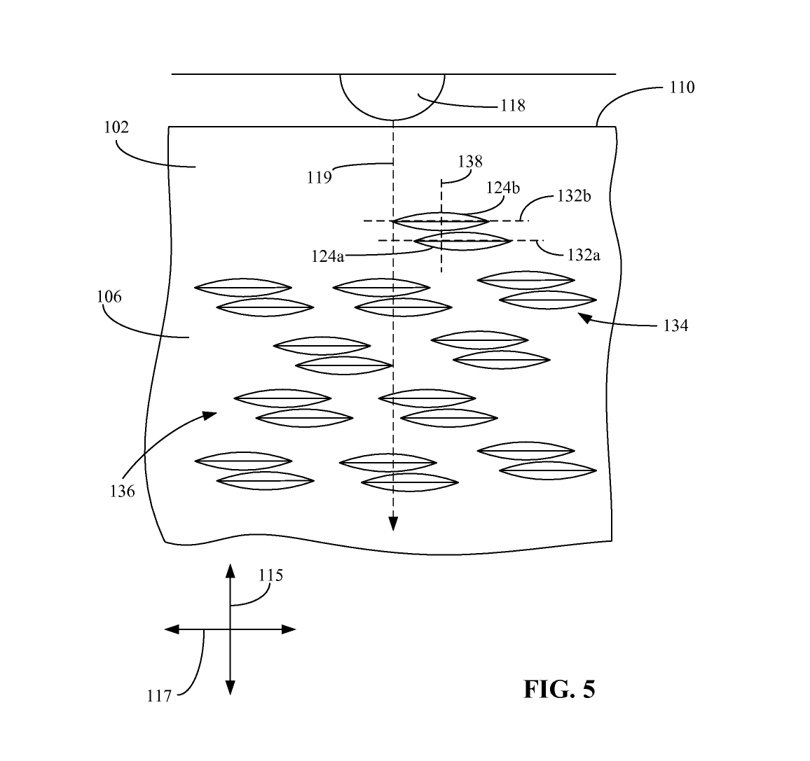

FIG. 5 shows parts of a lighting assembly 100 including another exemplary array 136 of micro-optical element groupings 134. In the embodiment shown, each micro-optical element grouping 134 includes a first micro-optical element 124a adjacent a second micro-optical element 124b. The first micro-optical element 124a and the second micro-optical element 124b each have a respective longitudinal axis 132a, 132b at nominally the same orientation, parallel to one another and parallel to the light input edge 110 (e.g., parallel to an axis defined by the intersection of the light input edge 110 and one of the major surfaces 106, 108). In contrast with the exemplary micro-optical element groupings 134 shown in FIG. 4, the first micro-optical element 124a and the second micro-optical element 124b are laterally offset along an axis 138 that extends in the longitudinal direction 115 (e.g., orthogonal to an axis defined by the intersection of the light input edge 110 and one of the major surfaces 106, 108). The first micro-optical element 124a of a grouping 134 is located further from the light input edge 110 than the second micro-optical element 124b. In the example shown in FIG. 5, each micro-optical element grouping 134 is arranged at nominally the same orientation relative to the light input edge 110. As shown, each micro-optical element grouping 134 is arranged such that the longitudinal axes 132a, 132b are parallel to the light input edge 110. In other embodiments, the micro-optical element groupings 134 may have their respective longitudinal axes 132a, 132b arranged within the range of ±13° relative to the light input edge, similar to that described above in connection with FIG. 4.

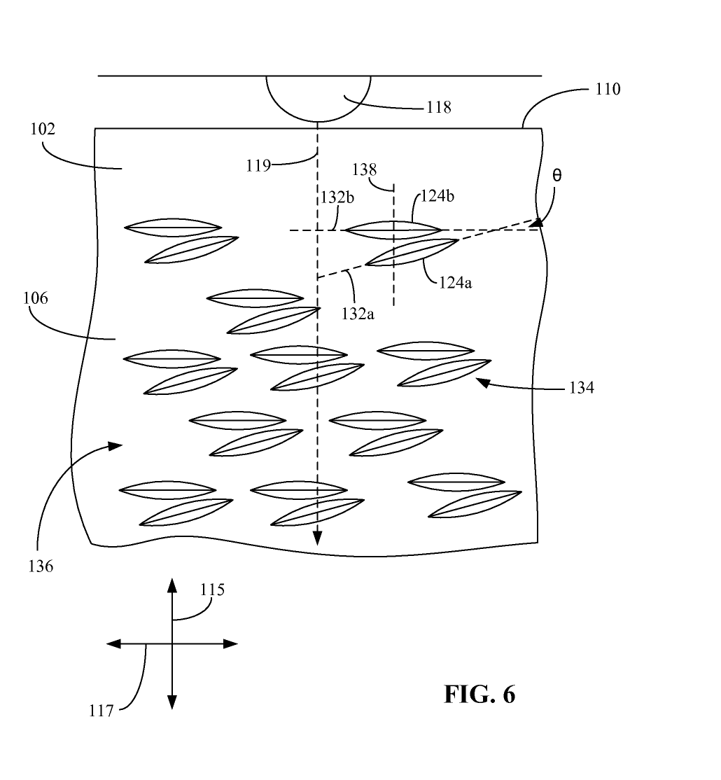

FIG. 6 shows parts of a lighting assembly 100 including another exemplary array 136 of micro-optical element groupings 134. In the embodiment shown, each micro-optical element grouping 134 includes a first micro-optical element 124a adjacent a second micro-optical element 124b. The first micro-optical element 124a and the second micro-optical element 124b each have a respective longitudinal axis 132a, 132b. The first micro-optical element 124a has a rotated orientation relative to the second micro-optical element 124b. As shown, the longitudinal axis 132a of the first micro-optical element 124a is arranged at an angle θ° relative to the longitudinal axis 132b of the second micro-optical element 124b. In the example shown, the angle θ° is approximately 20°. In other embodiments, the angle θ° may range from 5° to about 90°. In other embodiments, the angle θ° may range from 10° to about 45°. The first micro-optical element 124a and the second micro-optical element 124b are offset along an axis 138 that extends in the longitudinal direction 115 (e.g., orthogonal to an axis defined by the intersection of the light input edge 110 and one of the major surfaces 106, 108). The first micro-optical element 124a of a grouping 134 is located further from the light input edge 110 than the second micro-optical element 124b.

In the example shown in FIG. 6, each grouping is arranged at nominally the same orientation relative to the light input edge 110. As shown, each grouping is arranged such that the longitudinal axis 132b is parallel to the light input edge 110 and the longitudinal axis 132b is at an angle relative to the light input edge 110. In other embodiments, the micro-optical element groupings 134 may have their longitudinal axis 132b arranged within the range of ±β° relative to the light input edge, similar to that described above in connection with FIG. 4.

With additional reference to FIGS. 7-10, the arrangement of the micro-optical element grouping 134 may interact differently with on-axis and off-axis light propagating in the light guide. Light rays emitted at smaller angles relative to the optical axis 119 are referred to herein as “on-axis light rays.” Exemplary on-axis light rays are shown at 140, and reference numeral 140 is additionally used to refer to on-axis light rays collectively. Light rays emitted at larger angles relative to the optical axis 119 are referred to herein as “off-axis light rays.” Exemplary off-axis light rays are shown at 142 and 144, respectively, and reference numerals 142 and 144 are additionally used to refer to off-axis light rays collectively. As used in this disclosure, the terms “on-axis light rays” and “off-axis light rays” are used in a relative sense: on-axis light rays 140 propagate at smaller angles relative to the optical axis 119 than off-axis light rays 142, 144, but only a small fraction of the on-axis light rays 140 propagate along the optical axis 119 itself.

FIG. 7 shows parts of a lighting assembly 100 including another exemplary array 136 of micro-optical element groupings 134. The micro-optical elements 124a, 124b for each grouping 134 are arranged in the offset manner similar to that shown in FIG. 5, although the second micro-optical element 124b is larger than the first micro-optical element 124a. As shown, the respective micro-optical element groupings 134 are arranged such that on-axis light 140 or off-axis light 142, 144 from the light source 118 is incident thereon.

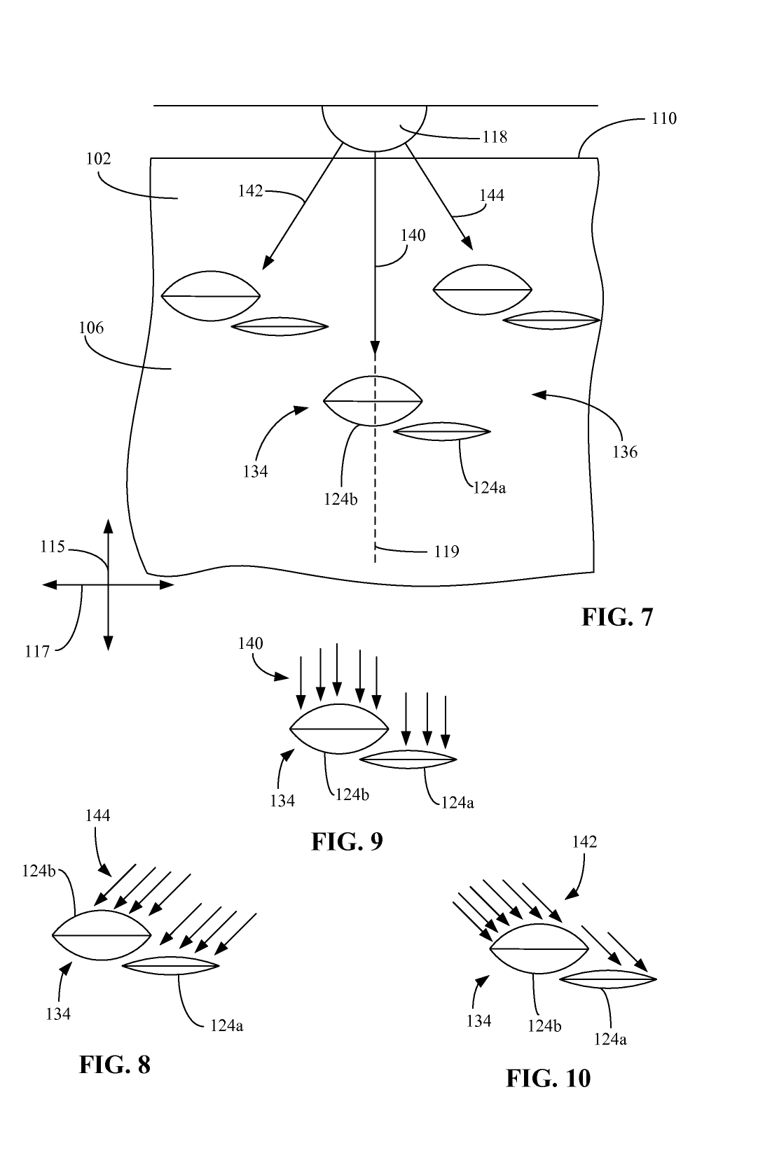

With additional reference to FIG. 8, the second micro-optical element 124b of the micro-optical element grouping 134 may have little or no interaction with the off-axis light 144 that is incident on the first micro-optical element 124a. As shown in FIG. 9, the second micro-optical element 124b of the micro-optical element grouping 134 partially overlaps the first micro-optical element 124a with respect to the on-axis light rays 140, and may therefore at least partially affect how the first micro-optical element 124a interacts with the on-axis light propagating in the light guide. As shown in FIG. 10, the second micro-optical element 124b of the micro-optical element grouping 134 mostly overlaps the first micro-optical element 124a with respect to the off-axis light rays 144, and may therefore affect how the first micro-optical element 124a interacts with the off-axis light 144 propagating in the light guide to an extent greater than how the first micro-optical element 124a interacts with the on-axis light 140 and the off-axis light 142. Accordingly, a micro-optical element grouping 134 can be provided at a predetermined arrangement to affect the light output distribution. As described above, the respective micro-optical element groupings 134 may vary in the arrangement, number, shape, size, depth, height, slope angle, included angle, surface roughness, and/or index of refraction of the micro-optical elements. This variance among the micro-optical element groupings 134 may be implemented in order to achieve different interactions with the on-axis or off-axis light from the micro-optical element groupings.

The embodiments described above exemplify various arrangements of micro-optical element groupings. In addition to the arrangement, the respective micro-optical elements included within the micro-optical element groupings may have any suitable shape, size, depth, height, slope angle, included angle, surface roughness, and/or index of refraction to affect the incidence of propagating light on one of the micro-optical elements of the grouping by another one of the micro-optical elements of the grouping and achieve a desired light output distribution.

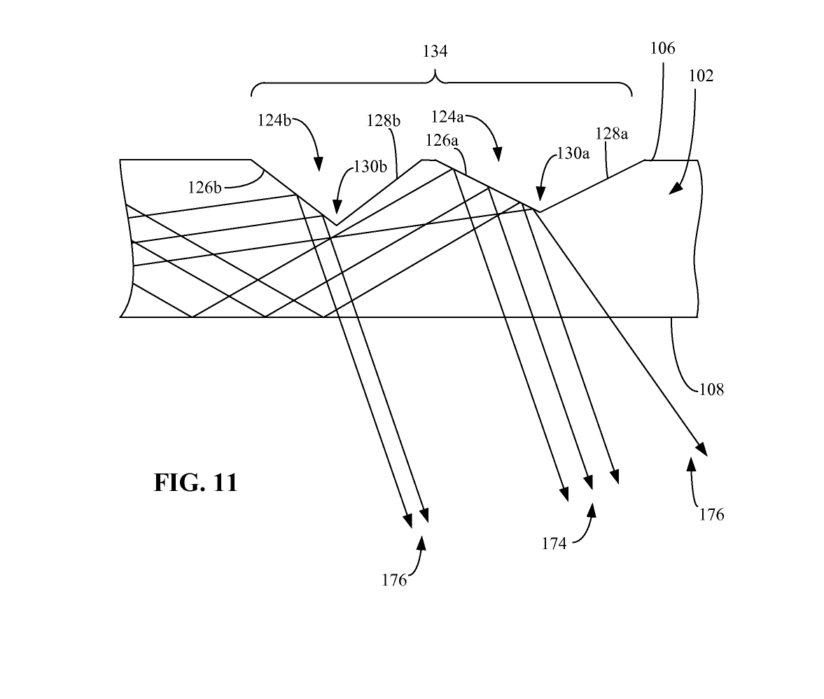

As described above, for a given micro-optical element grouping 134, one of the micro-optical elements (e.g., the second micro-optical element 124b) may be configured to redirect at least a portion of the light incident thereon away from a propagation path that would cause the light to be incident another of the grouped micro-optical elements (e.g., the first micro-optical element 124a). FIG. 11 shows the extraction of light from the light guide 102 by an exemplary micro-optical element grouping 134 having such a configuration. In the embodiment shown, the first micro-optical element 124a is embodied as an indentation in the major surface 106 of the light guide 102 having a similar configuration to the micro-optical element shown in FIG. 3. The first micro-optical element 124a includes a first side surface 126a and a second side surface 128a that come together to form a ridge 130a having ends that intersect the one of the major surfaces 106. In addition, a second micro-optical element 124b embodied as an indentation in the major surface 106 of the light guide 102 is arranged adjacent the first micro-optical element 124a and closer to the light input edge. The second micro-optical element 124b includes a first side surface 126b and a second side surface 128b that come together to form a ridge 130b having ends that intersect the one of the major surfaces 106. The second micro-optical element 124b has a different (e.g., smaller) included angle than the first micro-optical element 124a (e.g., about 110°).

In the arrangement shown, the second micro-optical element 124b creates a shadow on the first micro-optical element 124a, blocking certain modes of propagating light of from being incident on the light redirecting surface of the first micro-optical element 124a. Otherwise, if such light did reach the first micro-optical element 124a, the light may be reflected in a manner that would cause an undesired glare angle (e.g., as described above in connection with FIG. 3). As shown in FIG. 11, a first portion of the light 174 input to and propagating in the light guide at a first mode is incident the first side surface 126a of the first micro-optical element 124a, and is extracted from the light guide 102 (e.g., at an angle within a predetermined light ray angle distribution). A second portion 176 of the light input to and propagating in the light guide at a second mode is at least partially blocked from the first micro-optical element 124a by the second micro-optical element 124b. The second micro-optical element 124b is configured to extract the light propagating in the light guide at the second mode from the light guide 102 (e.g., at an angle within the predetermined light ray angle distribution). Some of the second portion 176 of the light input to and propagating in the light guide 102 at the second mode may still be incident the first micro-optical element 124a and may still be extracted at an unwanted angle (e.g., falling outside the predetermined light ray angle distribution), but the presence of the second micro-optical element 124b may reduce this from occurring.

FIG. 12 shows the extraction of light from the light guide by a micro-optical element grouping 134 having a configuration where the second micro-optical element 124b in the micro-optical element grouping 134 refracts propagating light so that it is not incident the first micro-optical element 124a and stays coupled in the light guide 102. In the embodiment shown, the first micro-optical element 124a is embodied as an indentation in the major surface 106 of the light guide 102 having a similar configuration to the micro-optical element shown in FIG. 3. The first micro-optical element 124a includes a first side surface 126a and a second side surface 128a that come together to form a ridge 130a having ends that intersect the one of the major surfaces 106. In addition, a second micro-optical element 124b is embodied as an indentation in the major surface 106 of the light guide 102 arranged adjacent the first micro-optical element 124a and closer to the light input edge. The second micro-optical element 124b includes a first side surface 126b and a second side surface 128b that come together to form a ridge 130b having ends that intersect the one of the major surfaces 106. The second micro-optical element 124b has a different (e.g., smaller) included angle than the first micro-optical element 124a (e.g., about 30°).

As shown, a first portion 178 of the light input to and propagating in the light guide 102 at a first mode is incident the first side surface 126a first micro-optical element 124a, and is extracted from the light guide 102 (e.g., at an angle within a predetermined light ray angle distribution). A second portion 180 of the light input to and propagating in the light guide 102 at a second mode is incident the second micro-optical element 124b. If this second portion 180 of the light did reach the first micro-optical element 124a, the light may be reflected in a manner that would cause an undesired glare angle (e.g., as shown in FIG. 3). But as shown, the second micro-optical element 124b is configured to refract the second portion 180 of the light such that the second portion 180 of the light is refracted and remains coupled in the light guide 102. Hence, light that would cause glare if initially incident on the first micro-optical element 124a instead remains coupled in the light guide 102. Some of the second portion 180 of the light input to and propagating in the light guide 102 at the second mode may still be incident the first micro-optical element 124a and may still be extracted at an unwanted angle (e.g., falling outside the predetermined light ray angle distribution), but the presence of the second micro-optical element 124b may reduce this from occurring.

As also described above, for a given micro-optical element grouping 134, light can be redirected by one of the grouped micro-optical elements (e.g., the second micro-optical element 124b) to interact with the other grouped micro-optical element (e.g., the first micro-optical element 124a) differently than if such light was initially incident the other grouped micro-optical element.

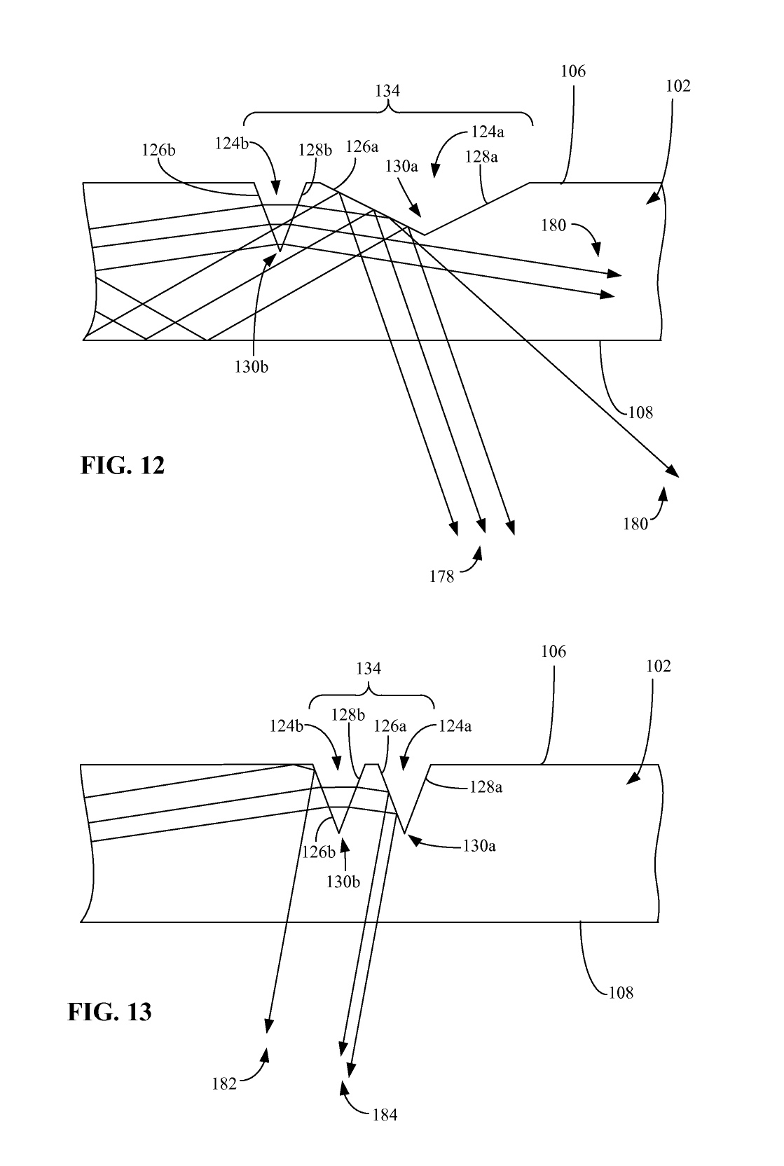

FIG. 13 shows the extraction of light from the light guide 102 by a micro-optical element grouping 134 having a configuration where the second micro-optical element 124b in the micro-optical element grouping 134 refracts propagating light in a direction toward the first micro-optical element 124a so that the refracted light is extracted from the light guide 102 by the first micro-optical element 124a (e.g., at an angle within a predetermined light ray angle distribution). In the embodiment shown, the first micro-optical element 124a and the second micro-optical element 124b are embodied as indentations in the major surface 106 of the light guide and have similar configurations. The first micro-optical element 124a includes a first side surface 126a and a second side surface 128a that come together to form a ridge 130a having ends that intersect the one of the major surfaces 106. The second micro-optical element 124b includes a first side surface 126b and a second side surface 128b that come together to form a ridge 130b having ends that intersect the one of the major surfaces 106. The included angle of each of the first micro-optical element 124a and the second micro-optical element 124b is about 30°. The second micro-optical element 124b is arranged adjacent the first micro-optical element 124a and closer to the light input edge.

As shown, a first portion 182 of the light input to and propagating in the light guide 102 is reflected at the major surface 106 of the light guide 106, is incident first side surface 126a of the second micro-optical element 124b, and is reflected and output from the light guide 102 through the major surface 108 (e.g., at an angle within a predetermined light ray angle distribution). A second portion 184 of the light input to and propagating in the light guide 102 is initially incident the first side surface 126b of the second micro-optical element 124b. As shown, the second micro-optical element 124b is configured such that the second portion 184 of the light is refracted by the first and second side surfaces 126b, 128b, is incident on the first side surface 126a of the first micro-optical element 124a, and is then reflected and output from the major surface 108 of the light guide 102 (e.g., at an angle within the predetermined light ray angle distribution). Hence, the second portion 184 of the light is transmitted by the second micro-optical element 124b at an angle to interact with the first micro-optical element 124a.

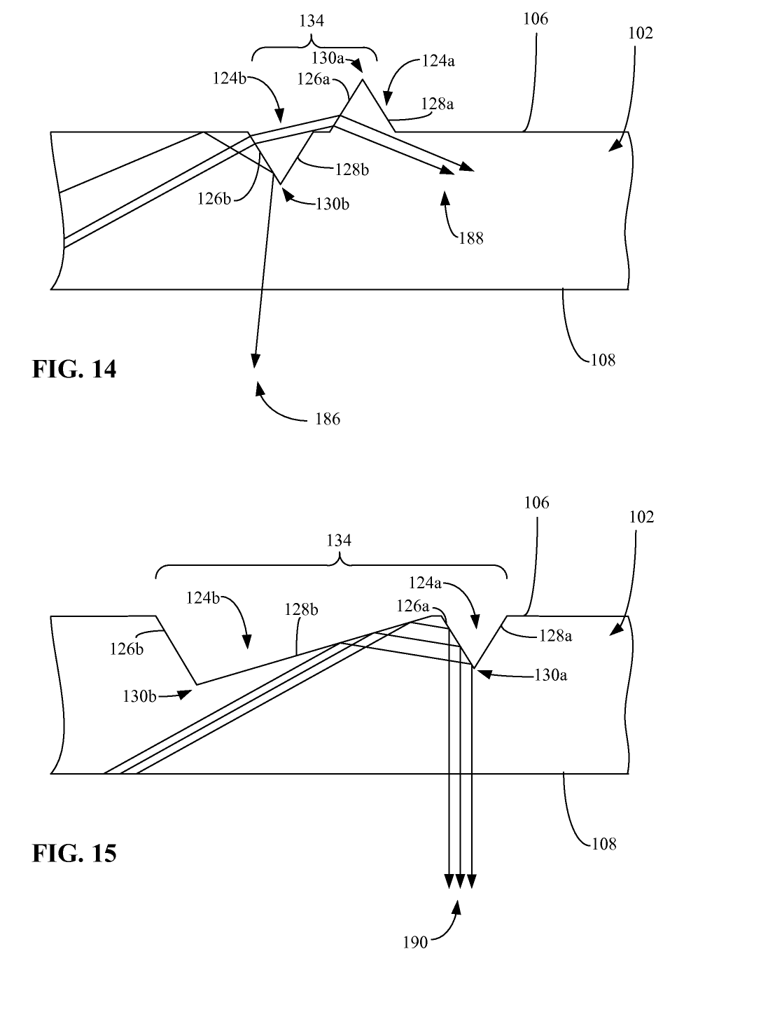

FIG. 14 shows the extraction of light from the light guide 102 by a micro-optical element grouping 134 having a configuration where the second micro-optical element 124b in the micro-optical element grouping refracts propagating light so that it is incident the first micro-optical element 124a. In the embodiment shown, the second micro-optical element 124b is embodied as an indentation having an included angle of about 30°; and the first micro-optical element 124a is embodied as a protrusion having an included angle of about 30°. The first micro-optical element 124a includes a first side surface 126a and a second side surface 128a that come together to form a ridge 130a having ends that intersect the one of the major surfaces 106. The second micro-optical element 124a includes a first side surface 126b and a second side surface 128b that come together to form a ridge 130b having ends that intersect the one of the major surfaces 106. The second micro-optical element 124b is arranged adjacent the first micro-optical element 124a and is closer to the light input edge.

As shown, a first portion 186 of the light input to and propagating in the light guide 102 is reflected at the major surface 106 of the light guide 102, is incident the first side surface 126b of the second micro-optical element 124b, and is reflected and output from the major surface 108 of the light guide 102 (e.g., at an angle within a predetermined light ray angle distribution). A second portion 188 of the light input to and propagating in the light guide 102 is initially incident the first side surface 126b of the second micro-optical element 124b. The micro-optical elements 124a, 124b are configured such that the second portion 188 of the light is refracted by the first side surface 126b of the second micro-optical element 124b and is incident on the first side surface 126a of the first micro-optical element 124a. The first micro-optical element 124a is configured such that the light re-enters and remains coupled in the light guide 102. In some embodiments (although not specifically shown), the light re-entering the light guide may be reflected by the second side surface 128a of the first micro-optical element 124a and extracted from the major surface 108 of the light guide 102 (e.g., at an angle within the predetermined light ray angle distribution).

FIG. 15 shows the extraction of light from the light guide by a micro-optical element grouping 134 having a configuration where the second micro-optical element 124b in the micro-optical element grouping 134 reflects propagating light so that it is incident the first micro-optical element 124a. In the embodiment shown, the first micro-optical element 124a is embodied as an indentation having an included angle of about 30°. The first micro-optical element 124a includes a first side surface 126a and a second side surface 128a that come together to form a ridge 130a having ends that intersect the one of the major surfaces 106. The second micro-optical element 124b is embodied as an asymmetric indentation having an included angle of about 120°. The second micro-optical element 124b includes a first side surface 126b and a second side surface 128b that come together to form a ridge 130b having ends that intersect the one of the major surfaces 106. As shown, a portion 190 of the light input to and propagating in the light guide 190 is incident the second side surface 128b of the second micro-optical element 124b. The incident light is reflected toward the first micro-optical element 124a, is incident the first side surface 128a of the first micro-optical element 124a, and is reflected and output from the light guide 102 (e.g., at an angle within a predetermined light ray angle distribution).

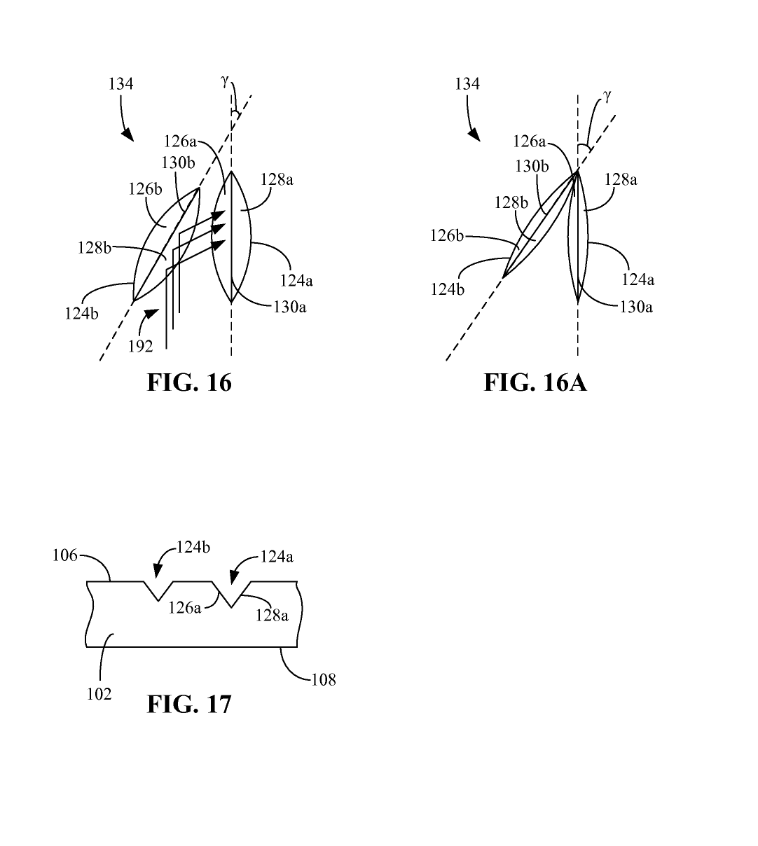

As described above, the micro-optical element groupings 134 may be configured to achieve a desired light output distribution from the lighting assembly 100. In some embodiments, this may entail spreading the light extracted from the light guide laterally (e.g., in the lateral direction 117). Exemplary micro-optical element groupings 134 configured to spread the extracted light laterally are shown in FIGS. 16-21.

FIGS. 16 and 17 show an exemplary micro-optical element grouping 134. In the embodiment shown, the micro-optical element grouping 134 includes a first micro-optical element 124a adjacent a second micro-optical element 124b. The first micro-optical element 124a includes a first side surface 126a and a second side surface 128a that come together to form a ridge 130a having ends that intersect the one of the major surfaces 106. The second micro-optical element 124b includes a first side surface 126b and a second side surface 128b that come together to form a ridge 130b having ends that intersect the one of the major surfaces 106. The first micro-optical element 124a and the second micro-optical element 124b each have a respective longitudinal axis 132a, 132b, and the first micro-optical element 124a has a rotated orientation relative to the second micro-optical element 124b. As shown, the longitudinal axis 132a of the first micro-optical element 124a is arranged at an angle γ° relative to the longitudinal axis 132b of the second micro-optical element 124b. In the example shown, the angle γ° is approximately 30°. In other embodiments, the angle γ° may range from 10° to about 80°.

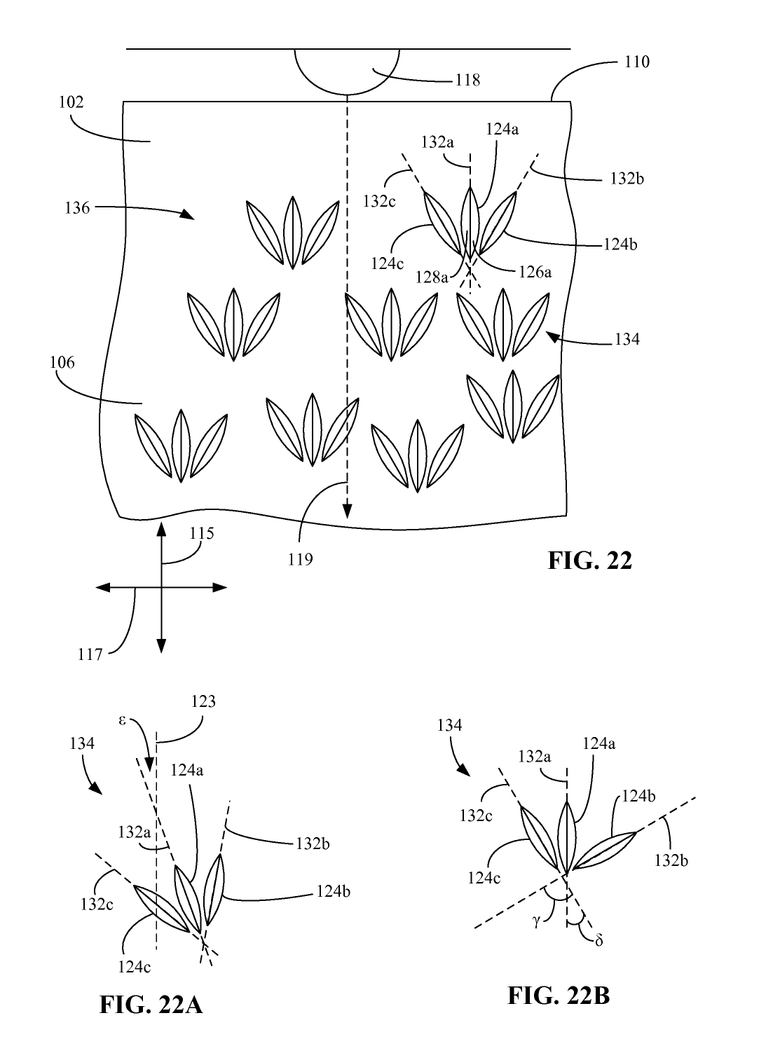

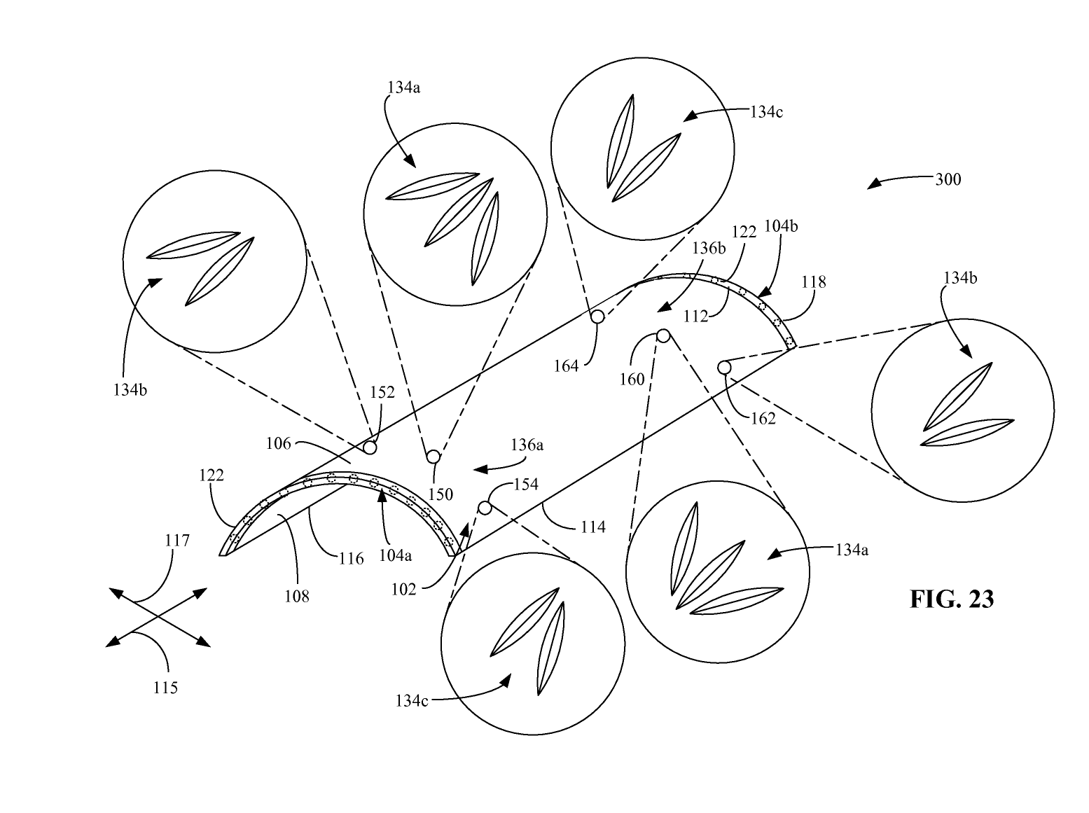

The micro-optical element grouping 134 may be arranged such that the longitudinal axis 132a of the first micro-optical element 124a is nominally orthogonal to the light input edge (e.g., orthogonal to an axis defined by the intersection of the light input edge 110 and one of the major surfaces 106, 108). In other embodiments, the micro-optical element grouping 134 may be arranged such that the longitudinal axis 132a is at an angle relative to the light input edge and the longitudinal axis 132b is at an angle relative to the longitudinal axis 132a of the first micro-optical element (e.g., and at an angle relative to the light input edge). For example, as described below with reference to FIG. 22, the micro-optical element grouping 134 may be arranged with the longitudinal axis 132a within the range of ±β° relative to the light input edge.

As shown in FIG. 16, a portion 192 of light input to and propagating in the light guide is incident the second micro-optical element 124b. The second micro-optical element 124b is configured to reflect the incident light toward the first micro-optical element 124a. The reflected light incident the first micro-optical element 124a is reflected and output from the light guide (e.g., at an angle within the predetermined light ray angle distribution). In the embodiment shown, the redirection provided by the second micro-optical element 124b may allow for lateral spreading of the light extracted by the light guide 102.

FIG. 17 shows a cross-sectional view of the micro-optical element grouping 134 in the light guide 102 (e.g., as viewed from the light input edge). As shown, the micro-optical elements 124a, 124b are embodied as indentations in the light guide 102. In the illustrated embodiment, the first micro-optical element 124a is configured as a deeper indentation than the second micro-optical element 124b. This may allow for more of the light reflected from the second micro-optical element 124b to be incident the first micro-optical element 124a. In other embodiments, the depth of the first micro-optical element 124a is the same as the depth of the second micro-optical element 124b.

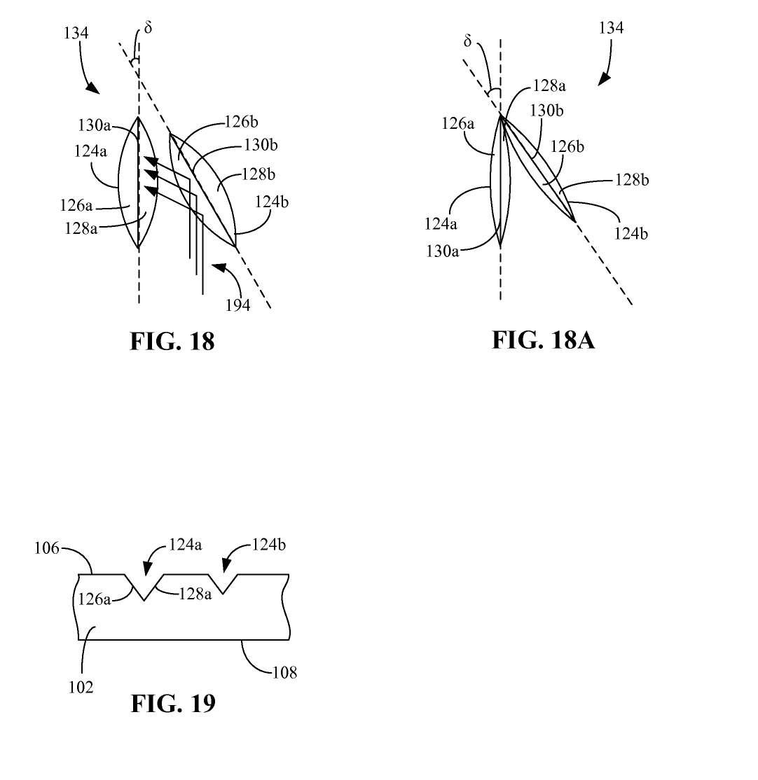

FIGS. 18 and 19 show another exemplary micro-optical element grouping 134. The micro-optical element grouping 134 shown in FIGS. 18 and 19 is a mirror image of the micro-optical element grouping 134 shown in FIGS. 16 and 17. As such, the micro-optical element grouping 134 shown in FIGS. 18 and 19 may extract light in a lateral direction opposite to the lateral direction of the light extracted by the micro-optical element grouping 134 shown in FIGS. 16 and 17. The micro-optical element grouping 134 includes a first micro-optical element 124a adjacent a second micro-optical element 124b. The first micro-optical element 124a includes a first side surface 126a and a second side surface 128a that come together to form a ridge 130a having ends that intersect the one of the major surfaces 106. The second micro-optical element 124b includes a first side surface 126b and a second side surface 128b that come together to form a ridge 130b having ends that intersect the one of the major surfaces 106. The first micro-optical element 124a and the second micro-optical element 124b each have a respective longitudinal axis 132a, 132b, and the first micro-optical element 124a has a rotated orientation relative to the second micro-optical element 124b. As shown, the longitudinal axis 132a of the first micro-optical element 124a is arranged at an angle δ° relative to the longitudinal axis 132b of the second micro-optical element 124b. In the example shown, the angle δ° is approximately 30°. In other embodiments, the angle δ° may range from 10° to about 80°.

The micro-optical element grouping 134 may be arranged such that the longitudinal axis 132a is orthogonal to the light input edge (e.g., orthogonal to an axis defined by the intersection of the light input edge 110 and one of the major surfaces 106, 108). In other embodiments, the micro-optical element grouping 134 may be arranged such that the longitudinal axis 132a is at an angle relative to the light input edge and the longitudinal axis 132b is at an angle relative to the longitudinal axis 132a of the first micro-optical element (e.g., and at an angle relative to the light input edge). For example, as described below with reference to FIG. 22, the micro-optical element grouping 134 may be arranged with the longitudinal axis 132a within the range of ±13° relative to the light input edge.

As shown in FIG. 18, a portion 194 of light input to and propagating in the light guide is incident the second micro-optical element 124b. The second micro-optical element 124b is configured to reflect the incident light toward the first micro-optical element 124a. The reflected light incident the first micro-optical element 124a is reflected and output from the light guide (e.g., at an angle within the predetermined light ray angle distribution). In the embodiment shown, the redirection provided by the second micro-optical element 124b may allow for lateral spreading of the light extracted by the light guide 102.

FIG. 19 shows a cross-sectional view of the micro-optical element grouping 134 in the light guide 102 (e.g., as viewed from the light input edge). As shown, the micro-optical elements 124a, 124b are embodied as indentations in the light guide 102. In the illustrated embodiment, the first micro-optical element 124a is configured as a deeper indentation than the second micro-optical element 124b. This may allow for more of the light reflected from the second micro-optical element 124b to be incident the first micro-optical element 124a. In other embodiments, the depth of the first micro-optical element 124a is the same as the depth of the second micro-optical element 124b.

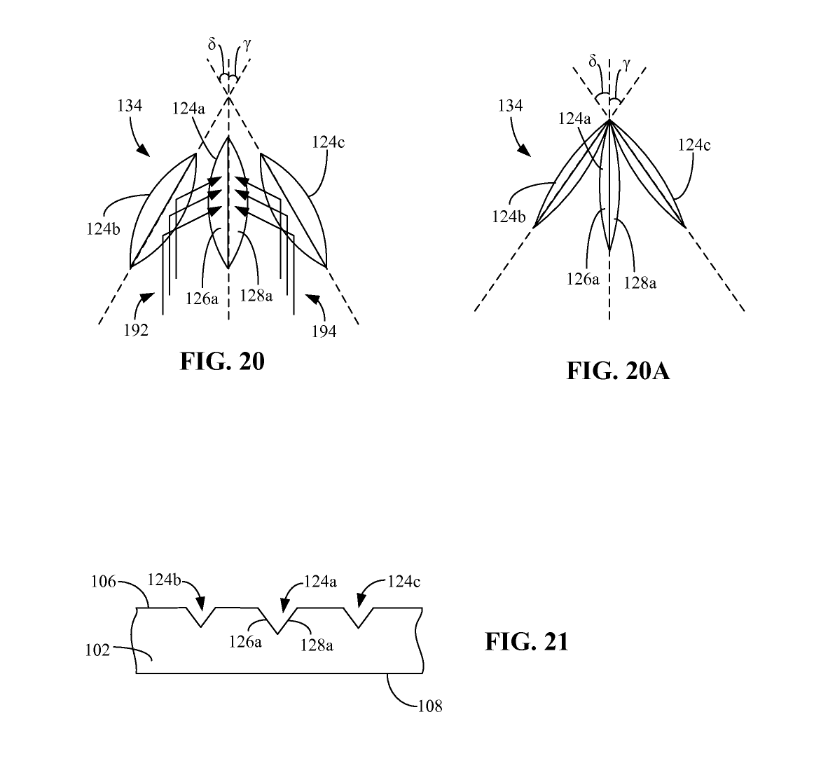

FIGS. 20 and 21 show another exemplary micro-optical element grouping 134.

The micro-optical element grouping 134 shown in FIGS. 20 and 21 is a combination of the micro-optical element grouping shown in FIGS. 16 and 17 and the micro-optical element grouping shown in FIGS. 18 and 19. In the embodiment shown, each micro-optical element grouping 125 includes three micro-optical elements. The first micro-optical element 124a includes a first side surface 126a and a second side surface 128a that come together to form a ridge 130a having ends that intersect the one of the major surfaces 106. The second micro-optical element 124b includes a first side surface 126b and a second side surface 128b that come together to form a ridge 130b having ends that intersect the one of the major surfaces 106. The third micro-optical element 124c includes a first side surface 126c and a second side surface 128c that come together to form a ridge 130c having ends that intersect the one of the major surfaces 106. The second micro-optical element 124b is adjacent the first side surface 126a of the first micro-optical element 124a. The third micro-optical element 124c is adjacent the second side surface 128a of the first micro-optical element 124a.

The first micro-optical element 124a, second micro-optical element 124b, and third micro-optical element 124c each have a respective longitudinal axis 132a, 132b, 132c; and the first micro-optical element, second micro-optical element, and third micro-optical element have a rotated orientation relative to one another. As shown, the longitudinal axis 132a of the first micro-optical element 124a is arranged at an angle γ° relative to the longitudinal axis 132b of the second micro-optical element 124b; and the longitudinal axis 132a of the first micro-optical element 124a is arranged at an angle δ° relative to the longitudinal axis 132c of the third micro-optical element 124c. In the example shown, the angle γ° and the angle δ° are each approximately 30°. In other examples, the angle γ° and the angle δ° may each range from 10° to about 80°. In some embodiments, the angle γ° and the angle δ° are nominally the same angle. In other embodiments, the angle γ° and the angle δ° are a different angle.

The micro-optical element grouping 134 may be arranged such that the longitudinal axis 132a is orthogonal to the light input edge. In other embodiments, the micro-optical element grouping 134 may be arranged such that the longitudinal axis 132a is at an angle relative to the light input edge. For example, as described below with reference to FIG. 22, the micro-optical element grouping 134 may be arranged with the longitudinal axis 132a within the range of ±β° relative to the light input edge.

As shown in FIG. 20, a portion 192 of light input to and propagating in the light guide is incident the second micro-optical element 124b. The second micro-optical element 124b is configured to reflect the incident light toward the first side surface 126a of the first micro-optical element 124a. The reflected light incident the first micro-optical element 124a is reflected and output from the light guide (e.g., at an angle within the predetermined light ray angle distribution). Additionally, a portion 194 of light input to and propagating in the light guide is incident the third micro-optical element 124c. The third micro-optical element 124c is configured to reflect the incident light toward the second side surface 128a of the first micro-optical element 124a. The reflected light incident the first micro-optical element 124a is reflected and output from the light guide (e.g., at an angle within the predetermined light ray angle distribution). In the illustrated embodiment, the lateral redirection provided by the second micro-optical element 124b and the third micro-optical element 124c may allow for the light extracted by the first micro-optical element to be spread in the lateral direction.

FIG. 21 shows a cross-sectional view of the micro-optical element grouping 134 in the light guide 102 (e.g., as viewed from the light input edge). As shown, the micro-optical elements 124a, 124b, 124c are embodied as indentations in the light guide 102. In the illustrated embodiment, the first micro-optical element 124a is configured as a deeper indentation than the second micro-optical element 124b and the third micro-optical element. This may allow for more of the light reflected from the second micro-optical element 124b and the third micro-optical element 124c to be incident the first micro-optical element 124a. In other embodiments, the depth of the first micro-optical element 124a is the same as the depth of the second and/or third micro-optical elements 124b, 124c.

In the embodiments described above in FIGS. 16-21, the micro-optical elements included in the micro-optical element grouping 134 differ with respect to their respective depths and orientation, but are otherwise nominally the same. In other embodiments, the micro-optical elements included in the micro-optical element grouping 134 may differ in one or more of size, shape, depth, height, slope angle, included angle, arrangement, and surface roughness, and/or index of refraction. As an example, one or more of the micro-optical elements may have an asymmetric shape. As another example, one or more of the micro-optical elements may have a shape other than the football-shaped micro-optical elements described above. Such parameters may provide for a desired light ray angle distribution of the light extracted by the micro-optical element grouping 134.

In the embodiments described above in FIGS. 16-21, the micro-optical elements included in the micro-optical element grouping 134 are shown as being spaced apart from one another. For example, in each of FIGS. 16 and 18, the micro-optical elements are arranged such that a space is provided between the micro-optical element 124a and the micro-optical element 124b. In FIG. 20, the micro-optical elements are arranged such that a space is provided between the micro-optical element 124a and the micro-optical element 124b; and a space is provided between the micro-optical element 124a and the micro-optical element 124c. With additional reference to FIGS. 16A, 18A, and 20A, the micro-optical elements included in the micro-optical element grouping 134 may be arranged such that they abut or are in contact with one or more other micro-optical elements in the micro-optical element grouping 134. For example, FIG. 16A shows an arrangement where an end of the micro-optical element 124b along its longitudinal axis 132b abuts an end of the micro-optical element 124a along its longitudinal axis 132a. FIG. 18A also shows an arrangement where an end of the micro-optical element 124b along its longitudinal axis 132b abuts an end of the micro-optical element 124a along its longitudinal axis 132a. FIG. 20A shows an arrangement where an end of the micro-optical element 124b along its longitudinal axis 132b abuts an end of the micro-optical element 124a along its longitudinal axis 132a; and an end of the micro-optical element 124c along its longitudinal axis 132c also abuts the end of the micro-optical element 124a along its longitudinal axis 132a. In other embodiments, although not specifically shown, the micro-optical elements included in the micro-optical element grouping 134 may be arranged such that they overlap and/or intersect with one or more other micro-optical elements in the micro-optical element grouping 134.

FIG. 22 shows parts of a lighting assembly 100 including an exemplary array 136 of micro-optical element groupings 134. In the embodiment shown, each micro-optical element grouping 132 is configured similar to the embodiment described above in connection with FIGS. 20 and 21. As shown, each micro-optical element grouping 134 is nominally the same and is respectively arranged such that the longitudinal axis 132a of the first micro-optical element 124a is nominally orthogonal to the light input edge (e.g., orthogonal to an axis defined by the intersection of the light input edge 110 and one of the major surfaces 106, 108). In other embodiments, the micro-optical element groupings 134 may have their respective longitudinal axes 132a, 132b arranged at an angle relative to orthogonal to the light input edge. For example, with additional reference to FIG. 22A, the micro-optical element 124a may be arranged with its longitudinal axis 132a within the range of ±ε° relative to orthogonal to the light input edge. ε is a positive or negative value to reference the direction of rotation of the micro-optical element relative to the corresponding light input edge. As exemplified in FIG. 22A, rotation in a counter-clockwise direction may provide a positive value of ε. Although not specifically shown, rotation in a clockwise direction may provide a negative value of ε. In some embodiments, this correlation of rotation direction to positive/negative angle may be reversed (e.g., counter-clockwise is considered negative and clockwise is considered positive).

In one example, the micro-optical element groupings 134 are arranged such that their longitudinal axis 132a is arranged within the range of +45° to −45° (±ε°) relative to an axis 123 extending orthogonal to the intersection of the light input edge 110 and one of the major surfaces 106, 108; and the respective rotational orientations from among the rotational orientations of the longitudinal axis 132a of the other micro-optical element groupings 134 in the array 136 may differ by no more than 90°. In another example, the micro-optical element groupings 134 are arranged such that their longitudinal axis 132a is arranged within the range of +30° to −30° (±ε°) relative to an axis 123 extending orthogonal to the intersection of the light input edge 110 and one of the major surfaces 106, 108; and the respective rotational orientations from among the rotational orientations of the longitudinal axis 132a of the other micro-optical element groupings 134 in the array 136 may differ by no more than 60°. In another example, the micro-optical element groupings 134 are arranged such that their longitudinal axis 132a is arranged within the range of +15° to −15° (±ε°) relative to an axis 123 extending orthogonal to the intersection of the light input edge 110 and one of the major surfaces 106, 108; and the respective rotational orientations from among the rotational orientations of the longitudinal axis 132a of the other micro-optical element groupings 134 in the array 136 may differ by no more than 30°. In another example, the micro-optical element groupings 134 are arranged such that their longitudinal axis 132a are arranged within the range of +10° to −10° (±ε°) relative to an axis 123 extending orthogonal to the intersection of the light input edge 110 and one of the major surfaces 106, 108; and the respective rotational orientations from among the rotational orientations of the longitudinal axis 132a of the other micro-optical element groupings 134 in the array 136 may differ by no more than 20°.

Accordingly, in some embodiments, the micro-optical element groupings 134 may be oriented in the same manner relative to the light input edge (e.g., whether the longitudinal axis 132a is orthogonal to the light input edge or at a non-orthogonal angle to the light input edge). In other embodiments, a portion of the micro-optical element groupings 134 that make up the array 136 may be arranged such that their longitudinal axis 132a is parallel to the light input edge; and another portion of the micro-optical element groupings 134 that make up the array 136 may be arranged such that their longitudinal axis 132a is arranged at a non-orthogonal angle relative to the light input edge.

In addition to or as an alternative to a variation in the angular orientation of the micro-optical element groupings 134 in the array 136, the micro-optical elements within a given micro-optical element grouping 134 in the array may differ from among other micro-optical elements within other micro-optical element groupings 134 in the array. In one example, and with reference to FIG. 22B, the micro-optical element groupings 134 included in the array 136 may vary with respect to the angle γ° between the longitudinal axis 132a of the first micro-optical element 124a and the longitudinal axis 132c of the second micro-optical element 124b and/or the angle δ° between the longitudinal axis 132a of the first micro-optical element 124a and the longitudinal axis 132c of the third micro-optical element 124c. Hence, the micro-optical element groupings 134 in the array 136 may have different respective angles γ° and δ°. In another example, as described below, the array may include micro-optical element groupings 134 having different respective numbers of micro-optical elements. In still other examples, the micro-optical elements within a given micro-optical element grouping 134 in the array may differ in one or more of arrangement, shape, size, depth, height, slope angle, included angle, surface roughness, and/or index of refraction from among other micro-optical elements within other micro-optical element groupings 134 in the array.

In the embodiments described above in FIG. 22, the micro-optical element groupings 134 included in the array 136 are shown as being spaced apart from one another. For example, as shown in FIG. 22, the micro-optical element groupings are each arranged such that a space is provided between itself and the adjacent micro-optical element groupings. In other embodiments, although not specifically shown, the micro-optical element groupings 134 included in the array 136 may be arranged such that they abut, are in contact with, overlap, and/or intersect one or more other micro-optical element groupings 134 in the array 136.

FIG. 23 shows parts of a lighting assembly 300 including a plurality of exemplary arrays 136a, 136b of micro-optical element groupings 134. The lighting assembly 300 shown is embodied as a lighting fixture (e.g., an overhead lighting fixture). The light guide 102 is configured as a semi-cylindrical body curving about an axis that extends along the longitudinal direction 115 between edge surface 110 and edge surface 112. The lighting assembly includes two light sources 104a and 104b respectively located at the edge surface 110 and edge surface 112. Accordingly, each of edge surface 110 and edge surface 112 are light input edges. The light guide 102 includes two arrays 136a, 136b of micro-optical element groupings. The first array 136a corresponds to the light input edge 110 and the first light source 104a. The second array 136b corresponds to the light input edge 112 and the second light source 104b.

Each array 136a, 136b includes different types of micro-optical element groupings 132. In the embodiment shown, three different types of groupings are provided in each array 136a, 136b. The first type of micro-optical element grouping 134a is embodied as the micro-optical element grouping shown in FIGS. 20 and 21. The second type of micro-optical element grouping 134b is embodied as the micro-optical element grouping shown in FIGS. 16 and 17. The third type of micro-optical element grouping 134c is embodied as the micro-optical element grouping shown in FIGS. 18 and 19.

In the embodiment shown, micro-optical element groupings of the first type 134a are located proximate the center of the light guide in the lateral direction 117. As shown, the array 136a includes a first type of micro-optical element groupings 134a at an exemplary location 150; and the array 136b includes a first type of micro-optical element groupings 134a at an exemplary location 160. Micro-optical element groupings of the second type 134b are located proximate the end of the light guide in the lateral direction 117 (e.g., proximate end edge 116 for the array 136a, and proximate end edge 114 for the array 136b). As shown, the array 136a includes the second type of micro-optical element groupings 134b at an exemplary location 152; and the array 136b includes the second type of micro-optical element groupings 134b at an exemplary location 162. Micro-optical element groupings of the third type 134b are located proximate the opposite end of the light guide in the lateral direction 117 (e.g., proximate end edge 114 for the array 136a, and proximate end edge 116 for the array 136b). As shown, the array 136a includes the third type of micro-optical element groupings 134c at an exemplary location 154; and the array 136b includes the third type of micro-optical element grouping 134c at an exemplary location 164.

In some embodiments, although not specifically shown, the micro-optical element groupings of the first type 134a are also located proximate the ends of the light guide in the lateral direction 117. As an example, the percentage of the first type of micro-optical element groupings 134a from among the micro-optical element groupings present at a given location of the light guide 102 may decrease with increasing distance from the center of the light guide in the lateral direction 117. Accordingly, in some embodiments, the percentage of the first type of micro-optical element groupings 134a from among the micro-optical element groupings at a location proximate the center of the light guide 102 in the lateral direction 117 is higher than the percentage of the first type of micro-optical element groupings 134a from among the micro-optical element groupings at a location proximate the end of the light guide 102 in the lateral direction 117. Similarly, in some embodiments, the percentage of the second type of micro-optical element groupings 134b from among the micro-optical element groupings present at a given location of the light guide 102 may decrease with increasing distance from an end of the light guide in the lateral direction 117. In some embodiments, the percentage of the third type of micro-optical element groupings 134c from among the micro-optical element groupings present at a given location of the light guide 102 may decrease with increasing distance from an end of the light guide in the lateral direction 117.

The first array 136a corresponds to the light input edge 110 and includes micro-optical element groupings located along the light guide in the longitudinal direction 115 from a location proximate the light input edge 110 toward the edge 112. Similarly the second array 136b corresponds to the light input edge 112 and includes micro-optical element groupings located along the light guide in the longitudinal direction 115 from a location proximate the light input edge 112 toward the edge 110. In some embodiments, the first array 136a and the second array 136b at least partially overlap. As an example, a location proximate the center of the light guide in the longitudinal direction 115 may include micro-optical element groupings from each of the arrays 136a and 136b. Other locations of the light guide may include micro-optical elements from only one of the arrays 136a and 136b. For example, at a location proximate the first light input edge 110, the light guide may only include micro-optical element groupings from the first array 136a. At location proximate the second light input edge 112, the light guide may only include micro-optical element groupings from the second array136b. In other examples, the arrays 136a and 136b may completely overlap.

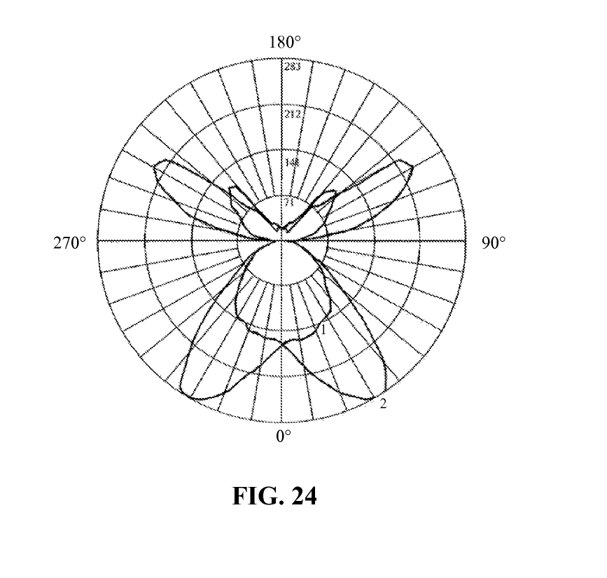

FIG. 24 is a light output distribution showing far-field light ray angle distributions of light extracted from the exemplary lighting assembly 300 of FIG. 23. The degree scale shown in FIG. 24 represents an azimuth relative to the normal of the major surface 106, 108. The output distribution profile shows the light distribution (vertical beam angle) in a first plane 1 orthogonal to the light input edge 110 and to the major surfaces 106, 108 of the light guide 102. For this distribution in the first plane 1, the first light source 104a is arranged adjacent the light input edge 110 proximate 270°, the second light source 104b is arranged adjacent the light input edge 112 proximate 90°, the major surface 106 is arranged proximate 180°, and the major surface 108 is arranged proximate 0°. The output distribution profile also shows the light distribution (horizontal beam angle) in a second plane 2 orthogonal to the side edges 114, 116 and to the major surfaces 106, 108 of the light guide 102. For this distribution, the lighting assembly is rotated 90°. Accordingly, the major surface 106 is arranged proximate 180°, the major surface 108 is arranged proximate 0°, and the first and second light sources 104 are arranged normal to the plane of the page.

As shown in FIG. 24, for the first plane 1 (showing vertical beam angle), each array 136a, 136b of the micro-optical elements groupings 134 specularly reflect the light input to the light guide 102 from the light source 104a, 104b through the major surface 108 of the light guide 102 with a vertical beam angle ranging of about 60.0°. The combined vertical beam angle of the light extracted through the major surface is about 120.0°. Such extracted light provides a light output distribution that may be suitable, e.g., in an overhead lighting fixture. Each array 136a, 136b of the micro-optical elements groupings 134 also specularly refract a second portion 152 of the light input to the light guide 102 from the light source 104 through the major surface 106 of the light guide 102 with a vertical beam angle of about 30.0°. For the second plane 2 (showing horizontal beam angle), each array 136a, 136b of the micro-optical elements groupings 134 specularly reflect the light input to the light guide 102 from the light source 104a, 104b through the major surface 108 of the light guide 102 with a horizontal beam angle of about 120.0°. This evidences the spreading of the light in the lateral direction as provided by the micro-optical element groupings. Each array 136a, 136b of the micro-optical elements groupings 134 also specularly refract the second portion 152 of the light through the major surface 106 of the light guide 102 with a horizontal beam angle of about 100.0°.

In this disclosure, the phrase “one of” followed by a list is intended to mean the elements of the list in the alternative. For example, “one of A, B and C” means A or B or C. The phrase “at least one of” followed by a list is intended to mean one or more of the elements of the list in the alternative. For example, “at least one of A, B and C” means A or B or C or (A and B) or (A and C) or (B and C) or (A and B and C).

What is claimed is:

1. A light guide, comprising:
a first major surface;
a second major surface opposed the first major surface;
a light input edge extending between the first major surface and the second major surface, the first major surface and the second major surface configured to propagate light input to the light guide through the light input edge therebetween by total internal reflection; and
micro-optical elements at at least one of the first major surface and the second major surface, the micro-optical elements arranged in an array of micro-optical element groupings, each micro-optical element grouping comprising:
a first micro-optical element; and
a second micro-optical element adjacent the first micro-optical element and arranged along a light propagation path extending from the light input edge, the second micro-optical element configured to redirect at least a portion of light propagating along the light propagation path and incident thereon toward the first micro-optical element such that the redirected light is incident the first micro-optical element and extracted from the light guide.

2. The light guide of claim 1, wherein for each micro-optical element grouping:
the first micro-optical element is configured as a v-groove-shaped depression having a first side surface and a second side surface that come together to form a ridge having ends that intersect the one of the major surfaces at which the micro-optical element is formed, and comprises a longitudinal axis parallel to the ridge; and
the second micro-optical element is configured as a v-groove-shaped depression having a first side surface and a second side surface that come together to form a ridge having ends that intersect the one of the major surfaces at which the micro-optical element is formed, and comprises a longitudinal axis parallel to the ridge.

3. The light guide of claim 2, wherein for each micro-optical element grouping, the longitudinal axis of the first micro-optical element is arranged orthogonal to the light input edge.

4. The light guide of claim 2, wherein for each micro-optical element grouping, the longitudinal axis of the first micro-optical element is arranged within the range of +45° to −45° relative to an axis extending orthogonal to the light input edge.

5. The light guide of claim 2, wherein:
the second micro-optical element is arranged adjacent one of the side surfaces of the first micro-optical element; and
the longitudinal axis of the second micro-optical element is arranged at an angle relative to the longitudinal axis of the first micro-optical element.

6. The light guide of claim 5, wherein:
each micro-optical element grouping comprises a third micro-optical element configured as a v-groove-shaped depression having a first side surface and a second side surface that come together to form a ridge having ends that intersect the one of the major surfaces at which the micro-optical element is formed, and comprises a third longitudinal axis parallel to the ridge and arranged at an angle relative to the first longitudinal axis, wherein:
the third micro-optical element is adjacent the other of the side surfaces of the first micro-optical element; and
the third micro-optical element is configured to redirect at least a portion of light propagating along the light propagation path and incident thereon toward the first micro-optical element such that the light is incident the first micro-optical element and extracted from the light guide.

7. The light guide of claim 6, wherein the angle formed between the longitudinal axis of the first micro-optical element and the longitudinal axis of the second micro-optical element is the same as the angle formed between the longitudinal axis of the third micro-optical element and the longitudinal axis of the first micro-optical element.

8. The light guide of claim 6, wherein the angle formed between the longitudinal axis of the first micro-optical element and the longitudinal axis of the second micro-optical element is different than the angle formed between the longitudinal axis of the third micro-optical element and the longitudinal axis of the first micro-optical element.

9. The light guide of claim 2, wherein a depth of the first micro-optical element in a direction extending between the first major surface and the second major surface is deeper than a depth of the second micro-optical element extending between the first major surface and the second major surface.

10. The light guide of claim 1, wherein the second micro-optical element is configured to reflect the at least a portion of light propagating along the light propagation path and incident thereon toward the first micro-optical element.

11. The light guide of claim 1, wherein the second micro-optical element is configured to refract the at least a portion of light propagating along the light propagation path and incident thereon toward the first micro-optical element.

12. The light guide of claim 1, wherein the second micro-optical element is further configured to extract another portion of the incident light from the light guide.

13. The light guide of claim 1, wherein the array of micro-optical element groupings is a first array corresponding to the light input edge, and the light guide further comprises a second array of micro-optical element groupings corresponding to an end edge opposite the light input edge and extending between the first major surface and the second major surface, each micro-optical element grouping of the second array comprising:
a first micro-optical element; and
a second micro-optical element adjacent the first micro-optical element and arranged along another light propagation path extending from the end edge, the second micro-optical element configured to redirect at least a portion of light propagating along the another light propagation path and incident thereon toward the first micro-optical element such that the redirected light is incident the first micro-optical element and extracted from the light guide.

14. A lighting assembly, comprising:
the light guide of claim 1; and
a light source adjacent the light input edge of the light guide and configured to edge light the light guide.

15. A light guide, comprising:
a first major surface;
a second major surface opposed the first major surface;
a light input edge extending between the first major surface and the second major surface, the first major surface and the second major surface configured to propagate light input to the light guide through the light input edge therebetween by total internal reflection; and
micro-optical elements at at least one of the first major surface and the second major surface, the micro-optical elements arranged in an array of micro-optical element groupings, each micro-optical element grouping comprising:
a first micro-optical element; and
a second micro-optical element adjacent the first micro-optical element and arranged along a light propagation path extending from the light input edge, the second micro-optical element configured to redirect at least a portion of light propagating along the light propagation path and incident thereon away from the first micro-optical element.

16. The light guide of claim 15, wherein for each micro-optical element grouping:
the first micro-optical element is configured as a v-groove-shaped depression having a first side surface and a second side surface that come together to form a ridge having ends that intersect the one of the major surfaces at which the micro-optical element is formed, and comprises a longitudinal axis parallel to the ridge; and
the second micro-optical element is configured as a v-groove-shaped depression having a first side surface and a second side surface that come together to form a ridge having ends that intersect the one of the major surfaces at which the micro-optical element is formed, and comprises a longitudinal axis parallel to the ridge.

17. The light guide of claim 16, wherein an included angle formed between the first side surface of the first micro-optical element and the second side surface of the first micro-optical element is different than the included angle formed between the first side surface of the second micro-optical element and the second side surface of the second micro-optical element.

18. The light guide of claim 15, wherein the second micro-optical element is configured to reflect the at least a portion of light propagating along the light propagation path and incident thereon away the first micro-optical element.

19. The light guide of claim 15, wherein the second micro-optical element is configured to refract the at least a portion of light propagating along the light propagation path and incident thereon away the first micro-optical element.

20. A lighting assembly, comprising:
the light guide of claim 15; and
a light source adjacent the light input edge of the light guide and configured to edge light the light guide.
